(19) United States
(12) Patent Application Publication
(10) Pub. No.: US 2018/0218718 A1
(43) Pub. Date: Aug. 2, 2018

(54) REPLACEMENT HEEL PEDESTAL DEVICE AND SYSTEM

(71) Applicant: John Elvan RENZI, Riverside, CA (US)

(72) Inventor: John Elvan RENZI, Riverside, CA (US)

(21) Appl. No.: 15/742,642

(22) PCT Filed: Aug. 9, 2016
(86) PCT No.: PCT/US16/46201

§ 371 Date: Jan. 8, 2018

Related U.S. Application Data
(63) Continuation-in-part of application No. 14/822,531, filed on Aug. 10, 2015, now abandoned.
(60) Provisional application No. 62/290,820, filed on Feb. 3, 2016.
(60) Provisional application No. 62/321,018, filed on Apr. 11, 2016.

(51) Int. Cl. G10D 13/00

(52) U.S. Cl. CPC G10D 13/006

(57) ABSTRACT

A replacement heel pedestal system comprising: a replacement heel pedestal top plate with a soft top surface, configured to engage a foot pedal, and comprising: a front; a bottom; two sides; a top; a rear; a slot opening, and a recessed portion. The slot opening may be a female notch on said front and said bottom of said replacement heel pedestal top plate that engages and couples with a tongue of a foot pedal. The tongue may be coupled to a foot pedal plate of the foot pedal, such that the replacement heel pedestal top plate and the foot pedal plate are hingedly coupled together. The recessed portion may be on the bottom and said front of the replacement heel pedestal top plate. The recessed portion may be configured to engage with a base plate of the foot pedal, level plate, and/or elevation plate.

### CROSS-REFERENCE TO RELATED APPLICATIONS

This Application is a National Stage PCT Application of PCT Application No. PCT/US2016/046201, filed on Aug. 9, 2016. The PCT Application No. PCT/US2016/046201 claims the benefit of (1) U.S. Non-Provisional patent application Ser. No. 14/822,531, filed on Aug. 10, 2015, titled “Replacement Drum Pedal Heel Pedestal”, by sole inventor John Elvan Renzi, (2) U.S. Provisional Patent Application No. 62/290,820, filed on Feb. 3, 2016, titled “Replacement Drum Pedal Heel Pedestal”, by sole inventor John Elvan Renzi, and (3) U.S. Provisional Patent Application No. 62/321,018, filed on Apr. 11, 2016, titled “Replacement Drum Pedal Heel Pedestal With LED Lights”, by sole inventor John Elvan Renzi, the contents of which all four Applications are expressly incorporated herein by this reference as though set forth in their entirety.

### FIELD

The present disclosure relates generally to a drum foot pedal apparatus, and more specifically, to a drum foot pedal heel pedestal or replacement heel pedestal system that is comfortable and may be easily connected to an existing drum foot pedal.

### BACKGROUND

Drumming is a very physically demanding and dynamic activity that requires a tremendous amount of muscle conditioning, endurance, strength, and coordination. In order to become a great drummer, the drummer generally must practice long hours, performing the same repetitive activity. This will help the drummer develop the necessary muscle memory and perform well on a frequent basis. For example, a drummer may reach 10,000 beats per minute when drumming for about one hour with only brief intervals between songs. Unfortunately, this may place the drummer at risk in developing various stress injuries relating to the supporting muscles and tendons.

Additionally, drummers are generally susceptible to developing pain behind their ankles due to the repetitive activity when playing the kick drum or drum instrument. Fatigue and injuries may also be exacerbated if the user is uncomfortable and overcompensating during long play sessions. Foot pedal heel plates that are currently available are generally made from metal or steel and are designed for a user that is playing with foot protection, such as a shoe. In order to prevent the shoed foot from slipping off the foot pedal, the metal heel plate is texturized in order to provide friction with the shoe. Moreover, current heel plates shapes are configured to mimic the narrow horseshoe or square shape of a shoe heel and generally do not provide a wide stable platform for the heel of a user.

U.S. Pat. No. 6,359,205, issued to Lombardi, discloses a drum foot pedal comprising a heel plate with treads on an upper surface. The heel plate is made from metal, may vary in thickness, and can be stacked with other metal plates to create an adjustment in height. However, the metal heel plate disclosed in Lombardi is uncomfortable without shoes and does not disclose that the heel plate is modular—that is maintains a wider and longer heel support base and it may not be used with many types of drum foot pedals.

Thus, there is a long felt need in the art for a modular replacement heel pedestal device and system that will improve a drummer or percussionist's hardware drum foot pedal system through a unique design of height adjustability, a longer width and length, and a comfortable and soft top surface that is comfortable, even without shoes, easy to attach to the existing drum foot pedal, and may be attached to various types of drum foot pedals.

### SUMMARY

To minimize the limitations in the cited references, and to minimize other limitations that will become apparent upon reading and understanding the present specification, the present specification discloses a new and improved replacement heel pedestal top plate and pedestal system.

One embodiment may be a replacement heel pedestal system comprising: a replacement heel pedestal top plate, configured to engage a foot pedal, and comprising: a front; a bottom; two sides; a top; a rear; a slot opening, and a recessed portion. The two sides may comprise a left side and a right side. The slot opening may be a female notch on the front and the bottom of the replacement heel pedestal top plate that may engage and couple with a tongue of a foot pedal. The tongue may be coupled to a foot pedal plate of the foot pedal, such that the replacement heel pedestal top plate and the foot pedal plate are hingedly coupled together. The recessed portion may be on the bottom and the front of the replacement heel pedestal top plate. The recessed portion is configured to engage with a base plate of the foot pedal. The slot opening may comprise one or more tongue pilot holes; and the one or more tongue pilot holes may be configured to align with one or more holes on the tongue, such that the tongue is allowed to matingly engage with and couple to the slot opening. The recessed portion of the replacement heel pedestal top plate may comprise one or more base plate pilot holes; and the one or more base plate pilot holes may be configured to align with one or more holes on the base plate, such that the base plate is allowed to matingly engage with and couple to the recessed portion. A surface of the top of the replacement heel pedestal top plate may be textured, such that a user's foot is substantially prevented from slipping off the replacement heel pedestal top plate. The surface of the top of the replacement heel pedestal top plate may be a soft urethane material that absorbs a shock to a foot of a user. This soft surface may also be comfortable for a user in bare or stocking feet. The replacement heel pedestal may be wider and longer than the original heel plate in order to accommodate a larger or smaller foot size and afford the drummer several foot positions for the heel of the foot to play from with more comfort and functionality when pealing the bass pedal system. The replacement heel pedestal top plate may taper from the front of the replacement heel pedestal top plate to the rear of the replacement heel pedestal top plate, such that the front is wider than the rear. The replacement heel pedestal top plate may be coupled to the tongue via one or more fasteners. The replacement heel pedestal top plate may be coupled to the base plate of the foot pedal via one or more fasteners. The recessed portion may be configured to matingly engage with the base plate, such that a heel end of the base plate engages with a proximal end of the recessed portion. The system may further comprise a level plate; wherein the level plate may be removeably coupled between the replacement heel pedestal top plate and the base plate, such that the replacement heel pedestal system is more level with respect to the foot pedal. The system may further comprise one or more elevation plates; wherein the one or more elevation plates may be removeably coupled between the replacement heel pedestal top plate and the base plate, such that a foot of a user is placed in an elevated playing position. This may provide overall body stability to enhance playing sustainability, comfort, and reducing injuries. The replacement heel pedestal top plate may further comprise four top edges and four top corners that may be substantially rounded.

Another embodiment may be a replacement heel pedestal system comprising: a replacement heel pedestal top plate, configured to engage a foot pedal, and comprising: a front; a bottom; two sides; a top; a rear; a slot opening, and a recessed portion. The two sides may comprise a left side and a right side. The slot opening may be a female notch on the front and the bottom of the replacement heel pedestal top plate that engages and couples with a tongue of a foot pedal. The tongue may be coupled to a foot pedal plate of the foot pedal, such that the replacement heel pedestal top plate and the foot pedal plate are hingedly coupled together. The hinge may have a hinge pin or be a living hinge. In other embodiments, the replacement heel pedestal top plate may have a male portion that interacts with a female portion of the foot pedal plate to matingly engage with the foot pedal. The recessed portion may be on the bottom and the front of the replacement heel pedestal top plate. The recessed portion may engage with a base plate of the foot pedal; and a surface of the top of the replacement heel pedestal top plate may be a soft urethane material that absorbs a shock to a foot of a user. The slot opening may comprise one or more tongue pilot holes; and the one or more tongue pilot holes may be configured to align with one or more holes on the tongue, such that the tongue is allowed to matingly engage with and couple to the slot opening. The recessed portion of the replacement heel pedestal top plate may comprise one or more base plate pilot holes; and the one or more base plate pilot holes may be configured to align with one or more holes on the base plate, such that the base plate is allowed to matingly engage with and couple to the recessed portion. The replacement heel pedestal top plate may be coupled to the tongue via one or more tongue fasteners and the replacement heel pedestal top plate may be coupled to the base plate of the foot pedal via one or more base fasteners. The recessed portion may be configured to matingly engage with the base plate, such that a heel end of the base plate engages with a proximal end of the recessed portion. A surface of the top of the replacement heel pedestal top plate may be textured, such that a user's foot is substantially prevented from slipping off the replacement heel pedestal top plate. The system may further comprise a level plate, wherein the level plate may be removeably coupled between the replacement heel pedestal top plate and the base plate, such that the replacement heel pedestal system is more level with respect to the foot pedal. The system may further comprise one or more elevation plates; wherein the one or more elevation plates may be removeably coupled between the replacement heel pedestal top plate and the base plate, such that a foot of a user is placed in an elevated playing position.

Another embodiment may be a method of replacing an original heel plate of a foot pedal with a replacement heel pedestal system comprising the steps: providing a foot pedal; wherein the foot pedal comprises: a foot pedal plate, an original heel plate, a base plate, and a tongue; wherein the original heel plate is connected to the base plate and the tongue via one or more fasteners; removing the one or more fasteners from the original heel plate; removing the original heel plate from the foot pedal; providing a replacement heel pedestal top plate; wherein the replacement heel pedestal top plate comprises: a front; a bottom; two sides; a top; a rear; a slot opening, and a recessed portion; wherein the two sides comprise a left side and a right side; wherein the slot opening is a female notch on the front and the bottom of the replacement heel pedestal top plate; coupling the tongue to the slot opening, such that the replacement heel pedestal top plate and the foot pedal plate are hingedly coupled together; wherein the recessed portion is on the bottom and the front of the replacement heel pedestal top plate; and coupling the base plate to the recessed portion of the replacement heel pedestal top plate. The method may further comprise removeably coupling a level plate between the replacement heel pedestal top plate and the base plate and/or removeably coupling one or more elevation plates between the replacement heel pedestal top plate and the base plate.

Another embodiment may be a replacement heel pedestal top plate, comprising a front portion, a bottom portion, two side portions, a top portion, and a rear portion. The front portion may comprise a slot opening. The bottom portion may comprise a recessed portion. The two side portions may comprise a left side portion and a right side portion. The recessed portion may be between the left side portion and the right side portion and extend from the left side portion to the right side portion. The recessed portion may be configured to matingly engage with the base plate of a drum foot pedal. The slot opening may be configured to matingly engage with the tongue of a drum foot pedal. The tongue may comprise one or more tongue fastener holes. The bottom portion of the replacement heel pedestal top plate may comprise one or more tongue pilot holes such that one or more tongue pilot holes may be configured to align one or more tongue fastener holes when the tongue of the drum foot pedal engages with the slot opening of the replacement heel pedestal top plate. The base plate of the drum foot pedal may comprise one or more base plate fastener holes. The bottom portion of the replacement heel pedestal top plate may comprise one or more base plate pilot holes such that one or more base plate pilot holes of the replacement heel pedestal top plate may be configured to align with one or more base plate fastener holes when the base plate of the drum foot pedal engages with the recessed portion of the replacement heel pedestal top plate. The top surface of the replacement heel pedestal top plate may be textured. The replacement heel pedestal top plate may taper from the front portion of the replacement heel pedestal top plate to the rear portion, such that the front portion may wider than the rear portion. The replacement heel pedestal top plate may be longer than an original heel plate. The replacement heel pedestal top plate may be fastened to the tongue of the drum foot pedal via one or more fasteners. The replacement heel pedestal top plate may be fastened to the base plate of the drum foot pedal via one or more fasteners wherein the fasteners may be selected from the group of fasteners consisting of a screw, a self-tapping screw, and/or an adhesive. The replacement heel pedestal top plate may be removeably coupled to a level plate. The level plate may comprise one or more base plate pilot holes. The one or more base plate pilot holes of the level plate may align with one or more base plate pilot holes of the replacement heel pedestal top plate when the level plate is removeably coupled with the replacement heel pedestal top plate. The replacement heel pedestal top plate may be removeably coupled to one or more elevation plates. The one or more elevation plates may comprise one or more tongue pilot holes and one or more base plate pilot holes. The one or more tongue pilot holes of the one or more elevation plates may align with one or more tongue pilot holes of the replacement heel pedestal top plate. The one or more base plate pilot holes of the one or more elevation plates may align with the one or more base plate pilot holes of the replacement heel pedestal top plate. The one or more elevation plates may be removeably coupled with the replacement heel pedestal top plate. The one or more elevation plates may be removeably coupled with the level plate. The level plate may be removeably coupled to the replacement heel pedestal top plate.

Another embodiment may be a method of replacing a drum foot pedal heel plate with a replacement heel pedestal. The drum foot pedal may comprise: a foot pedal, an original heel plate, a base plate, and a tongue. The original heel plate may be connected to the base plate and the tongue via one or more fasteners. One or more fasteners may be removed from the original heel plate and the original heel plate may be removed. A replacement heel pedestal top plate may be provided such that the replacement heel pedestal top plate may comprise a front portion, a top portion, two side portions, a bottom portion, and a rear portion. The front portion may comprise a slot opening. The bottom portion may comprise a recessed portion. The two side portions may comprise a left side portion and a right side portion. The recessed portion may be between the left side portion and the right side portion and extend from the left side portion to the right side portion. The recessed portion may engage with the base plate of the drum foot pedal. The slot opening may engage with the tongue of the drum foot pedal. The tongue may comprise one or more tongue fasteners holes. The bottom portion of the replacement heel pedestal top plate may comprise one or more tongue pilot holes. The tongue pilot holes may be configured to align with one or more tongue fastener holes when the tongue of the drum foot pedal engages with the slot opening of the replacement heel pedestal top plate. The base plate of the drum foot pedal may comprise one or more base plate fastener holes. The bottom portion of the drum foot pedal help may comprise one or more base plate pilot holes. The base plate pilot holes of the replacement heel pedestal top plate may be configured to align with one or more base plate fastener holes when the base plate of the drum foot pedal engages with the recessed portion of the replacement heel pedestal top plate. The top surface of the replacement heel pedestal top plate may be textured. The replacement heel pedestal top plate may taper from the front portion of the replacement heel pedestal top plate to the rear portion, such that the front portion may be wider than the rear portion. The heel pedestal may comprise four edges between the front, the back, the left side, and the right side, such that the four edges may be substantially rounded. The heel pedestal may comprise four corners, such that the four corners may be substantially rounded. The heel pedestal may be fastened to the tongue of the drum foot pedal via one or more fasteners. The tongue may be fastened to the replacement heel pedestal top plate via one or more fasteners. The base plate of the drum foot pedal may be fastened to the replacement heel pedestal top plate via one or more fasteners. The fasteners may be selected from the group of fasteners consisting of a screw, a self-tapping screw, and/or an adhesive. The bottom portion of the replacement heel pedestal top plate may be removeably coupled to a level plate. The level plate may comprise one or more base plate pilot holes. The one or more base plate pilot holes of the level plate may align with one or more base plate pilot holes of the replacement heel pedestal top plate when the level plate is removeably coupled with the replacement heel pedestal top plate. The base plate of the drum foot pedal may be fastened to the level plate and the replacement heel pedestal top plate via one or more fasteners. The replacement heel pedestal top plate may be removeably coupled with one or more elevation plates. The one or more elevation plates may comprise one or more tongue pilot holes and one or more base plate pilot holes. The one or more tongue pilot holes of the one or more elevation plates may align with one or more tongue pilot holes of the replacement heel pedestal top plate. The one or more base plate pilot holes of the one or more elevation plates may align with the one or more base plate pilot holes of the replacement heel pedestal top plate. The one or more elevation plates may be removeably coupled with the replacement heel pedestal top plate. The base plate of the drum foot pedal may be fastened to one or more elevation plates and the replacement heel pedestal top plate via one or more fasteners. The one or more elevation plates may be removeably coupled with the level plate. The level plate may be removeably coupled with the replacement heel pedestal top plate. The base plate of the drum foot pedal may be fastened to the level plate, one or more elevation plates, and the replacement heel pedestal top plate via one or more fasteners.

It is an object to provide a replacement heel pedestal top plate and pedestal system that is easy to install, comfortable when used without (or with) shoes, and may be installed on various types of drum foot pedals.

It is an object to provide a method for replacing an original heel plate with a heel pedestal system that is more comfortable and versatile and that does not damage the original heel plate or foot pedal system.

An additional objective is to provide a modular heel pedestal system that does not require substantial changes to existing drum foot pedals. The heel pedestal device and system disclosed herein may raise the heel height to achieve a desired angularity for ease of foot actuation of the pedal. It is an object to increase a drummer's stability, which may directly correlate to longer and more sustainable play while reducing player fatigue, which may reduce injuries.

It is an object to overcome the limitations of the prior art.

Other features and advantages will become apparent to those skilled in the art from the following detailed description and its accompanying drawings.

### BRIEF DESCRIPTION OF THE DRAWINGS

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

FIG. 1 is an illustration of a perspective view of a drum foot pedal of the prior art.

FIG. 2 is a flow block diagram of one embodiment of a method of replacing an original drum foot pedal heel plate with a replacement heel pedestal top plate.

FIG. 3 is an illustration of a perspective view of one embodiment of a replacement heel pedestal top plate attached to a drum foot pedal and base plate.

FIG. 4 is an illustration of a perspective view of one embodiment of a replacement heel pedestal system attached to a drum foot pedal and base frame.

FIG. 5 is an illustration of a top perspective view of one embodiment of a replacement heel pedestal top plate.

FIG. 6 is an illustration of a bottom perspective view of one embodiment of a replacement heel pedestal top plate.

FIG. 7 is an illustration of a front elevational view of one embodiment of a replacement heel pedestal top plate.

FIG. 8 is an illustration of a side transparent view of one embodiment of a replacement heel pedestal top plate engaged with a tongue and a base plate.

FIG. 9 is an illustration of a top perspective view of one embodiment of a level plate.

FIG. 10 is an illustration of a bottom perspective view of one embodiment of a level plate.

FIG. 11 is an illustration of a top perspective view of one embodiment of an elevation plate.

FIG. 12 is an illustration of a bottom perspective view of one embodiment of an elevation plate.

FIG. 13 is an illustration of an assembled perspective view of a drum foot pedal with a replacement heel pedestal top plate and a level plate.

FIG. 14 is an illustration of an assembled perspective view of a drum foot pedal with a replacement heel pedestal top plate and an elevation plate.

FIG. 15 is an illustration of an assembled perspective view of a drum foot pedal with a replacement heel pedestal top plate and more than one elevation plate.

FIG. 16 is an illustration of a front elevational view of two interconnected replacement heel pedestal systems.

FIG. 17 is an illustration of an assembled perspective view of a hi-hat pedal with a drum foot pedal heel pedestal system.

FIG. 18 is an illustration of a top perspective view of one embodiment of a cover system for covering an original heel plate of a foot pedal.

FIG. 19 is an illustration of a bottom perspective view of one embodiment of a cover system for covering an original heel plate of a foot pedal.

FIG. 20 is an illustration of an exploded top perspective view of one embodiment of a cover system for covering an original heel plate of a foot pedal.

FIG. 21a-b are illustrations of a top and bottom perspective view of another embodiment of a replacement heel pedestal device and system.

### DETAILED DESCRIPTION OF THE DRAWINGS

In the following detailed description of various embodiments, numerous specific details are set forth in order to provide a thorough understanding of various aspects of the embodiments. However, the embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 1-10% from the indicated number or range of numbers.

As used herein, the term “foot pedal” refers to a drum, hi-hat, or other type of percussion instrument foot pedal that engages the foot of a user in order to play a percussion instrument. The “foot pedal” may be a drum foot pedal, a hi-hat foot pedal, or any drum/percussion hardware, which requires a foot pedal system to play. Typically, the foot pedal may be comprised of a heel plate, a foot pedal plate (sometimes referred to as just a foot pedal), a base plate or base frame, a hinge component, which may have one or more tongues, a linkage, a drive system, and a beater.

As used herein the term “base plate” refers to a bottom support structure that is generally underneath the foot pedal plate. The base plate may be a plate, wire frame, or other similar structure that provides support to the system.

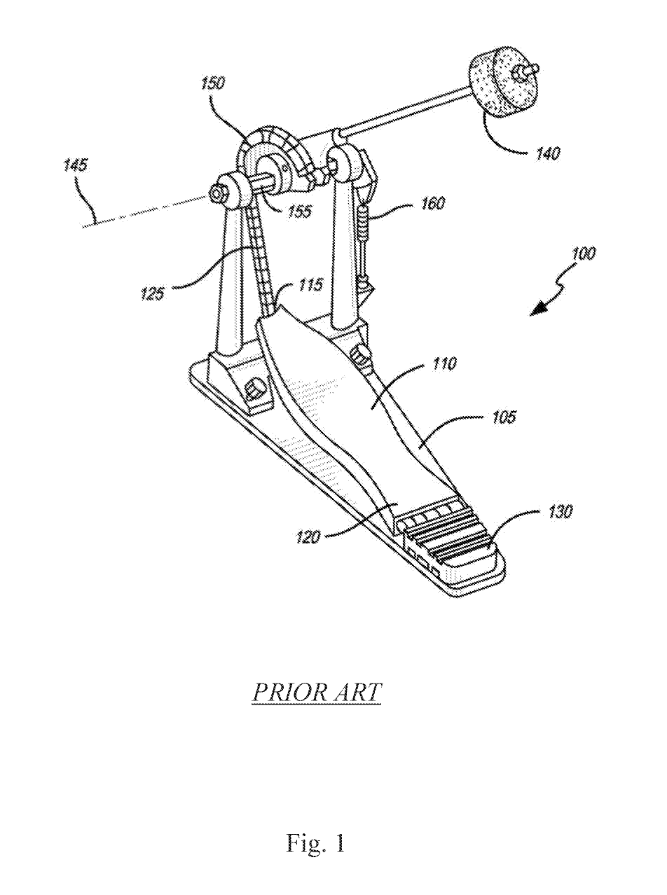

FIG. 1 is an illustration of a perspective view of a foot pedal of the prior art (drum, hi-hat, or other). The drum foot pedal 100 is a foot-operated lever used to control various mechanisms to play or modify the sounds of a musical instrument such as a drum or pair of hi-hat cymbals. As shown in FIG. 1, a drum foot pedal 100 generally comprises a base plate 105; a foot pedal plate 110 having a toe end 115 and a heel end 120. The toe end 115 may be connected to a linkage 125, such as a chain, and the heel end 120 may be fastened to an original heel plate 130 via a tongue. A drum beater 140, such as a mallet, may be actuated about a horizontal axis 145, in response to a downward pressure on the toe end 115 of the pedal 110. For example, in response to downward pressure on the pedal 110, the linkage 125 actuated by a rotor 150 and axle 155 may cause the drum beater 140 to rotate about an axis. A return spring 160 may be incorporated to provide resistance, thereby allowing the drum beater 140 to move to its original position. This will help the user to utilize the drum beater 140 again. Preferably, the heel plate 130 is removeable and may be replaced with the heel pedestal of the present disclosure.

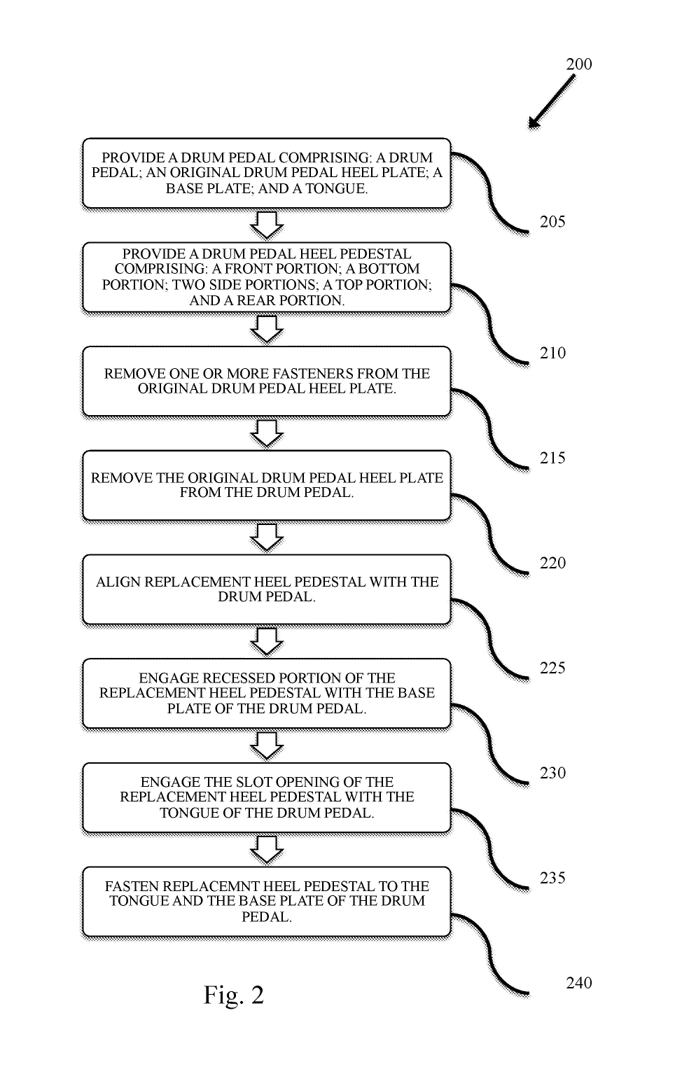

FIG. 2 is a flow block diagram of one embodiment of a method of replacing an original drum foot pedal heel plate with a replacement heel pedestal top plate. As shown in FIG. 2, one embodiment of the method 200 may comprise steps 205, 210, 215, 220, 225, 230, 235, and 240. FIG. 2 shows that the first step 205 is preferably to provide a drum foot pedal. As discussed above, a drum foot pedal 100 is generally a foot-operated lever used to control various mechanisms to play or modify the sounds of a musical instrument. Preferably, the drum foot pedal comprises: a drum foot pedal, with an original heel plate, a base plate, and a tongue. The original heel plate may be coupled to the base plate and the tongue via fasteners. The drum foot pedal may also comprise other components such as a linkage (e.g., chain), drum beater, (e.g., mallet), and return spring.

FIG. 2 also shows the second step 210, which may be to provide a drum foot pedal heel pedestal, also referred to as a replacement heel pedestal device and/or system. Preferably, the replacement heel pedestal top plate comprises: a front portion, a bottom portion, two side portions, a top portion, and a rear portion. The front portion may comprise a slot opening, which is generally an opening used to receive the tongue of a drum foot pedal. The bottom portion may comprise a recessed portion. The two side portions may comprise a left side portion and a right side portion. The recessed portion is preferably between the left side portion and the right side portion, and may extend from the left side portion to the right side portion. The recessed portion may be configured to matingly engage with the base plate of a drum foot pedal. The drum foot pedal heel pedestal system may be manufactured from any material including, but not limited to, plastic, polymer, resin, thixo, urethane, metal injection molding, liquid silicone rubber, wood, coated wood. laminated wood, particle board, composite wood, and/or compressed resin wood.

Next, the third step 215 of the method 200 may be to remove the fasteners from the original drum foot pedal heel plate. The fasteners may include base plate fasteners and tongue fasteners. These fasteners may be removed in various ways. For example, in various embodiments, the fasteners may be removed by unscrewing, heating, and the like. In another embodiment, a heat source may be applied in order to loosen the fasteners from the base plate fastener holes and the tongue fastener holes of the drum foot pedal. Once the fasteners are removed, the user may remove the original drum foot pedal heel plate from the drum foot pedal, as shown in the fourth step 220.

The method may also comprise the fifth step 225, which may be to align the replacement heel pedestal top plate and/or system with the drum foot pedal. Specifically, when the replacement heel pedestal system is engaged with the drum foot pedal, the tongue fastener holes on the base plate may align with the tongue fastener holes of the tongue and the tongue pilot holes of the replacement heel pedestal system. This may occur when the tongue of the drum foot pedal is fully inserted into the slot opening of the replacement heel pedestal. Similarly, the base plate fastener holes may align with one or more base plate pilot holes of the replacement heel pedestal when the replacement heel pedestal engages with the base plate. The user may then engage the recessed portion of the replacement heel pedestal with the base plate of the drum foot pedal, as shown in the sixth step 230. Similarly, the user may also engage the slot opening of the replacement heel pedestal with the tongue of the drum foot pedal, as shown in the seventh step 235.

Finally, the method 200 may comprise the eighth step 240, which may be to fasten the replacement heel pedestal top plate or system to the tongue and the base plate of the drum foot pedal. The user may utilize various fasteners, including, without limitation screws; self-tapping screws; bolts; nails; adhesives; welds; solders; ultrasonic welds; pins, keys; pegs; hook and loop; staples; buttons; zippers; anchors; rivets; grommets; latches; clasps; and clips. In the event that the replacement heel pedestal is constructed from material that is engageable with self-tapping screws, the pilot holes are not as necessary.

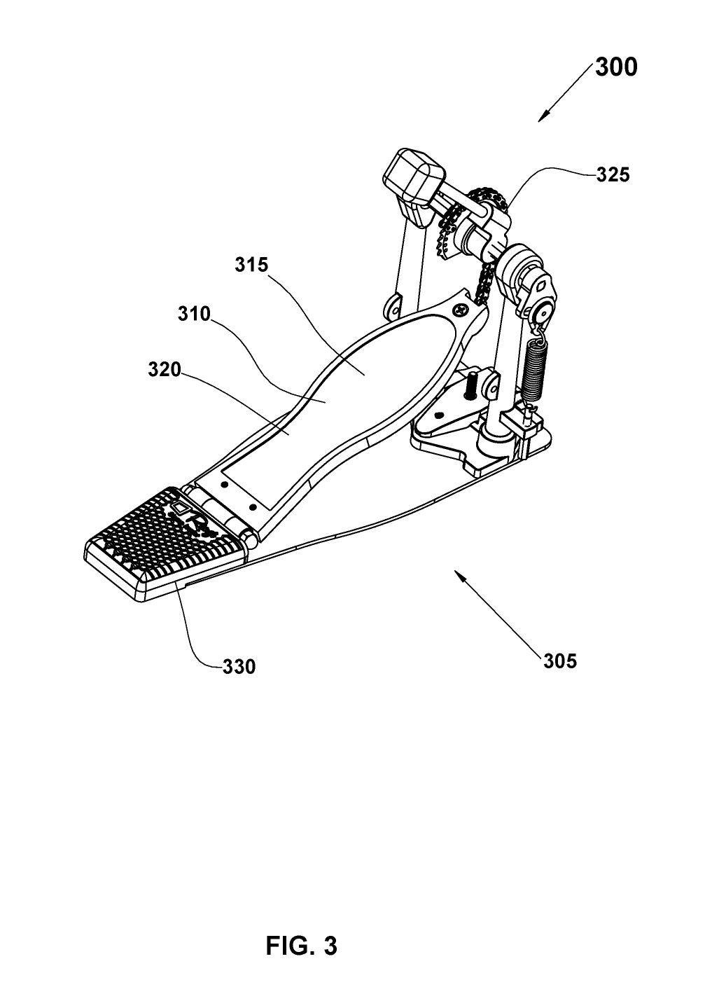

FIG. 3 is an illustration of a perspective view of one embodiment of a replacement heel pedestal top plate attached to a drum foot pedal and base plate. As shown in FIG. 3, the drum foot pedal 300 may comprise a base plate 305; a pedal 310 (also called a foot pedal plate or foot plate) having a toe end 315 and a heel end 320. The toe end 315 may be coupled to a linkage 325, such as a chain, and the heel end 320 may be fastened to a replacement heel pedestal top plate 330 via a tongue. The tongue may be fastened to the replacement heel pedestal top plate 330 via one or more fasteners. The base plate 305 may be a plate or a frame and may have various holes and/or connection mechanisms or fasteners to attach to the tongue and a heel plate (shown in FIG. 1) or replacement heel pedestal top plate 330. The tongue may also comprise one or more tongue fastener holes, which may cover and align with the tongue fastener holes in the base plate 305. Specifically, the tongue fastener holes on the base plate 305 are preferably configured to align with the tongue fastener holes of the tongue and the tongue pilot holes of the replacement heel pedestal top plate 330 when the tongue of the pedal 310 is inserted into the slot opening of the replacement heel pedestal top plate 330. Similarly, the base plate fastener holes may align with one or more base plate pilot holes of the replacement heel pedestal top plate 330 when the replacement heel pedestal top plate 330 engages with the base plate 305. The replacement heel pedestal top plate 330 may also fasten to the base plate 305 of the drum foot pedal 300 via fasteners.

In one embodiment, the tongue of the pedal 310 may not matingly fit into the slot opening of the replacement heel pedestal top plate 330. Accordingly, the tongue of the pedal 310 may need to be unfastened from the heel end 320 of the pedal 310 and rotated approximately 180 degrees. Rotation of the tongue approximately 180 degrees may provide the correct configuration of the tongue such that the tongue may fit into the slot opening of the replacement heel pedestal top plate 330. The tongue is essentially a dual plate hinge that connects the replacement heel pedestal 330 to the foot pedal 310. The replacement pedestal 330 is designed to engage with one or more original equipment manufacturer foot pedals.

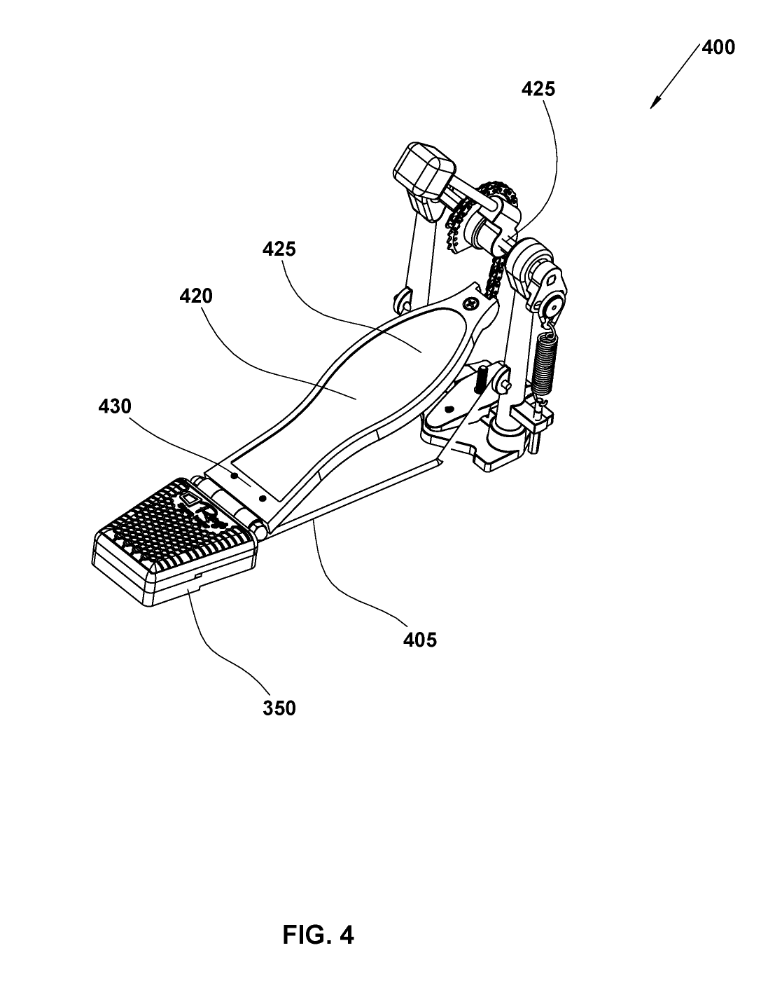

FIG. 4 is an illustration of a perspective view of one embodiment of a replacement heel pedestal system attached to a drum foot pedal and base frame. FIG. 4 is substantially the same as FIG. 3; however, the drum foot pedal 400 may comprise a base frame 405 instead of a base plate (as shown in FIG. 3). The base frame 405 may comprise a left frame and a right frame that run along the sides of the foot pedal 400. The base frame 405 may provide structural support for the foot pedal. The pedal 420 may comprise a toe end 425 and a heel end 430. The toe end 425 may be connected to a linkage 435, such as a chain, and the heel end 430 may be fastened to a replacement, heel pedestal system 350 via a tongue. The tongue may be fastened to the replacement heel pedestal system 350 via one or more fasteners. The tongue may comprise one or more tongue fastener holes, which are preferably configured to align with the tongue pilot holes of the replacement heel pedestal system 350 when the tongue of the pedal 420 is inserted into and/or overlaid onto the slot opening of the replacement heel pedestal system 350.

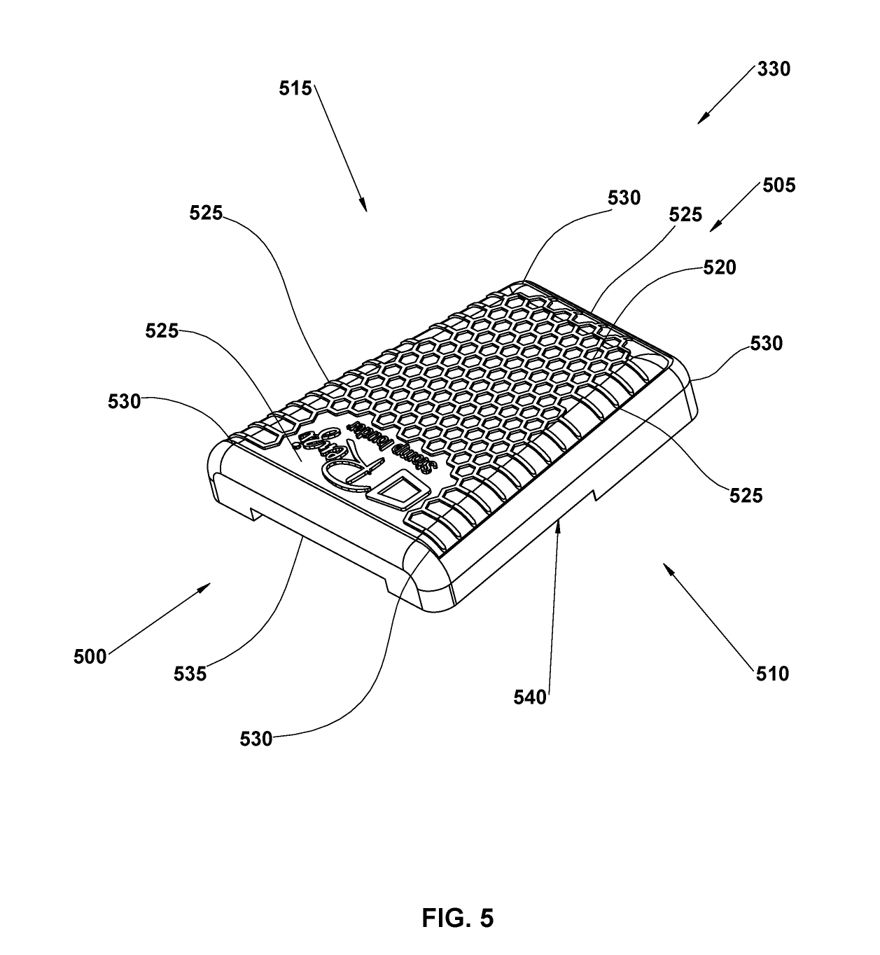

FIG. 5 is an illustration of a top perspective view of one embodiment of a replacement heel pedestal top plate. As shown in FIG. 5, one embodiment of the replacement heel pedestal top plate 330 may comprise: a front 500, rear 505, two side 510, 515, top surface 520, and a bottom surface. The top surface 520 of the replacement heel pedestal top plate 330 may be textured. The texture may comprise various patterns, including, without limitation, a honeycomb pattern, in order to reduce heel slippage. This pattern may be incorporated into the softer top surface, which may be a soft urethane.

Additionally, FIG. 5 shows that the front 500 of the replacement heel pedestal top plate 330 may taper to the rear 505, such that the front portion 500 is wider than the rear portion 505. The top plate 330 is preferably longer and wider than the original heel plate that it is replacing. As shown, the edges 525 of the replacement heel pedestal top plate 330 may also be curved or rounded, in order to provide additional comfort to the user. Similarly, the corners 530 of the replacement heel pedestal top plate 330 may also be curved or rounded to provide additional comfort to the user. The front 500 of the replacement heel pedestal top plate 330 may comprise a slot opening 540, which is generally an opening used to receive the tongue of a drum foot pedal.

The bottom of the replacement heel pedestal top plate 330 may comprise a recessed portion 35. The two sides 510, 515 may comprise a left side 510 and a right side 515. Accordingly, the recessed portion 540 is preferably between the left side portion 510 and the right side portion 515 and may extend from the left side portion 510 to the right side portion 515. The end of the recessed portion 540 may be configured to matingly engage with an end of a base plate (or frame) of a drum foot pedal.

In one embodiment, the replacement heel pedestal top plate 330, sometimes referred to as a drum foot pedal heel pedestal or a replacement drum foot pedal heel pedestal, may further comprise of a light emitting diode (LED) system. The LED system may comprise one or more LED lights, a color selection module, and a wiring harness. The color selection module may allow a user to change the color of the LED lights. The wiring harness may be used to electrically couple the LED system to a power source. The LED system may illuminate the replacement heel pedestal top plate 330 (and/or replacement heel pedestal system) at any time before, during, and/or after use. In this embodiment, the replacement heel pedestal top plate 330 (and/or replacement heel pedestal system) may be constructed of a clear Thermal Polymer Urethane (TPU) like material, which may allow the LED lights to illuminate the replacement heel pedestal top plate. Preferably, this embodiment may be used in situations where a drum kit also provides illumination.

The replacement pedestal 330 (and/or replacement heel pedestal system) preferably has a larger top surface area than the heel plate that it is replacing. It may be both wider and longer. The grip pattern and larger surface area combine to provide increased foot stability correlating to increased player performance and sustainability (endurance). The top surface 520 is preferably a soft urethane (or other shock absorbing and soft material, including memory foam) that provides a cushioned area for the foot and heel and replaces the standard harsh steel or metal fabricated heel pad. The softer top surface 520 absorbs the sock of the foot during pedaling the drum pedal. It also provides a softer area for resting, finessing, or stomping, and/or when using various types of pedaling techniques or playing styles, such as the “heel down”, “heel up”, or “heel toe” techniques. This shock absorbing top surface 520 absorbs significant loads, which directly correlates to reducing overall foot and body stress. The soft urethane top surface 520 may be a separate part of the replacement pedestal 330, which is layered over a harder plastic or polymer base. The top surface 520 may be coupled to the base of the pedestal 330 with an adhesive, ultrasonic welding, or other mechanism for permanently affixing the two portions together. In some embodiments, the top surface may not be a separate portion, may not be softer, and may not be textured. In some embodiments the top surface may be removeably couple to the pedestal 330, such that the user may interchange the surface for a replacement surface.

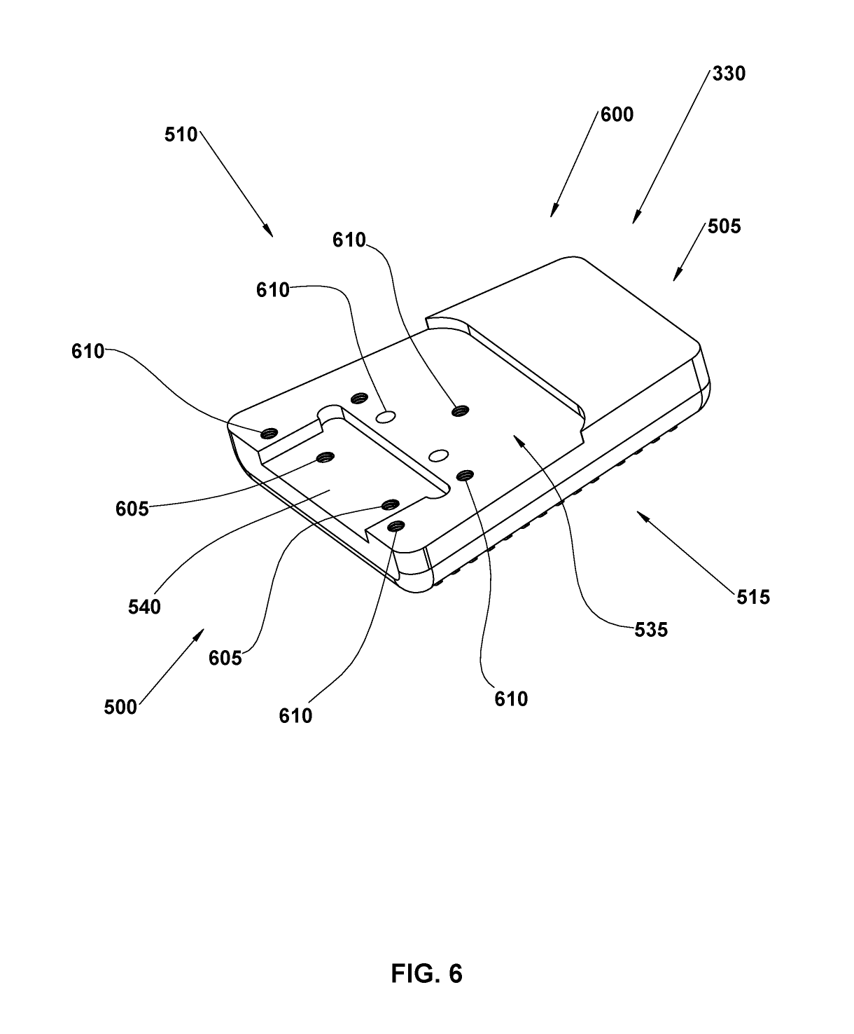

FIG. 6 is an illustration of a bottom perspective view of one embodiment of a replacement heel pedestal top plate. FIG. 6 shows that the bottom portion 600 of the replacement heel pedestal top plate 330 may comprise a recessed portion 535. The recessed portion 535 is preferably between the left side portion 510 and the right side portion 515, and may extend from the left side portion 510 to the right side portion 515. The recessed portion 535 may be rounded or otherwise configured to matingly engage with a base plate of a drum foot pedal at a proximal end of the recessed portion 535. The replacement heel pedestal top plate 330 may be tapered inwardly from the front 500 to the rear 505, such that the front 500 may be wider than the rear 505. In this manner, the replacement heel pedestal top plate 330 may better engage with the base plate.

The replacement heel pedestal top plate 330 may comprise one or more pilot holes 605, 610, which may be tongue pilot holes 605 and base plate pilot holes 610. The pilot holes are generally positioned at the bottom surface 600 of the replacement heel pedestal top plate 330. The tongue pilot holes 605 are generally configured to align with the tongue fastener holes of the tongue when the tongue of the drum foot pedal is inserted into the slot opening 540. The base plate pilot holes 610 may be configured to align with the base plate fastener holes when the bottom portion 600 of the replacement heel pedestal top plate 330 mates or engages with the base plate of the drum foot pedal. Additionally, the replacement heel pedestal top plate 330 may be fastened to the tongue and/or base plate of the drum foot pedal via one or more fasteners. The fasteners may be any connection mechanism, device, or method, including, without limitation screws; self-tapping screws; bolts; nails; adhesives; welds; solders; ultrasonic welds; pins, keys; pegs; hook and loop; staples; buttons; zippers; anchors; rivets; grommets; latches; clasps; and clips. In the event that the drum pedal heel pedestal 330 is constructed from material that is engageable with self-tapping screws, the pilot holes 605, 610 are not as necessary.

The pilot holes 605, 610 may be positioned in various locations on the bottom portion 600 of the replacement heel pedestal top plate 330, depending upon the location of the holes on the tongue and base plate of the drum foot pedal. In this manner, the replacement heel pedestal top plate 330 is versatile and may be used with various types and brands of drum foot pedals.

FIG. 6 also shows the slot opening 540, which is preferably configured to matingly engage the tongue or allow the engagement of the tongue by the replacement heel pedestal 330.

The pilot holes, as shown may have inset metal threads in order to matingly engage with a screw that is interconnecting the pedestal 330 to the tongue or base plate.

The location and diameter of the pilot holes are preferably configured to align with one or more original equipment manufacturer drum foot pedals. Accordingly, several different embodiments of the pedestal may be provided in order to engage with various brands of drum foot pedals. In one embodiment the pedestal 330, level plates, and elevation plates may be configured to engage with drum foot pedals made by Drum Workshop®, including series 3000, 5000, 6000, 7000, 9000, and DW® Direct Drive™ (single and double bass pedal systems). In another embodiment, the pedestal 330, level plates, and elevation plates may be configured to engage with drum foot pedals made by Pearl®, including, but not limited to Eliminator Series: Powershifter P-2000C/P2002C, Eliminator Readline P2050C/P2050BL, P2052CL/P2052BL. In another embodiment, the pedestal 330, level plates, and elevation plates may be configured to engage with drum foot pedals made by Tama®, including the Cobra Series: Iron Cobra® 600, HP600DTW, HP200PTW, Cobra 900 Rolling Glide Single and Double Bass, Iron Cobra® 900 Power Glide Single, TAMHP900PSWN Coil Spring, PH900PSN Power Glide, HP900FSW Flexi Glide, TAMHP900RSWN Rolling Glide Twin Bass Pedal. One or more embodiments of the pedestal 330, level plates, and elevation plates may be configured to engage with Canopus™ brand drums foot pedals. One or more embodiments of the pedestal 330, level plates, and elevation plates may be configured to engage with other base drum foot pedals and/or hi-hat foot pedals of all brands or manufacturers who manufacture drum hardware comprising a foot pedal or foot pedal system.

To the extent that one or more of the pilot holes 610, 605 do not get used, a plug, threaded or otherwise may be inserted into the holes 605, 610 to prevent dirt from accumulating.

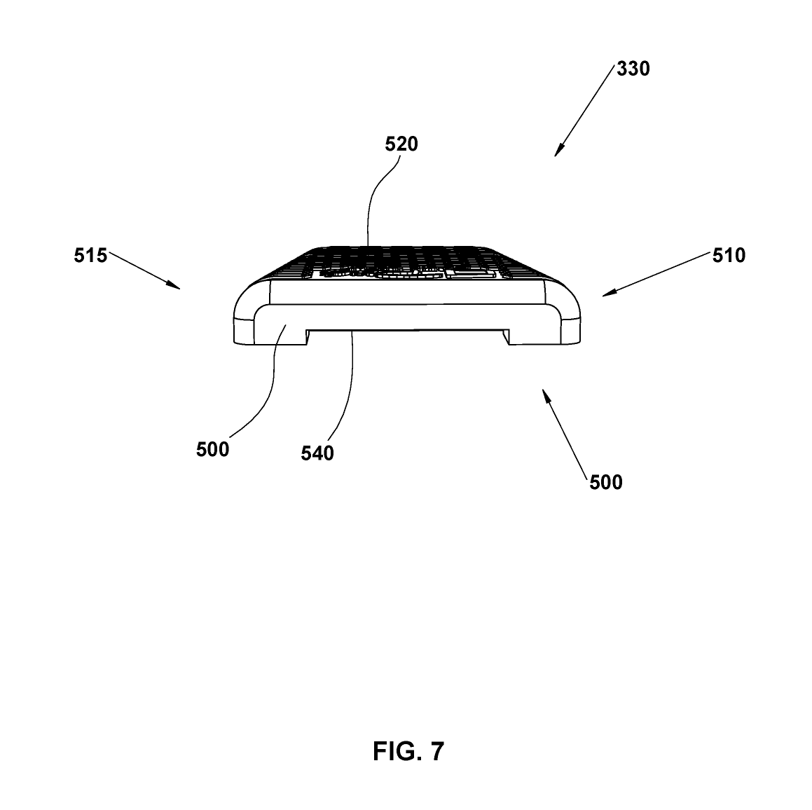

FIG. 7 is an illustration of a front elevational view of one embodiment of a replacement heel pedestal top plate. As shown in FIG. 7, one embodiment of the replacement heel pedestal top plate 330 may comprise a front 500, two side 510, 515, top surface 520, and a bottom surface 600. The front 500 may comprise a slot opening 540, which is generally an opening used to receive the tongue of a drum foot pedal. The two side portions 510, 515 may comprise a left side portion 510 and a right side portion 515.

The slot opening 540 may be on a planar surface and may be substantially parallel with the top surface 520 of the replacement heel pedestal top plate 330. The slot opening 540 may be configured to matingly engage with the tongue of a drum foot pedal, such that the tongue of the drum foot pedal is surrounded on three sides by and within the slot opening 540.

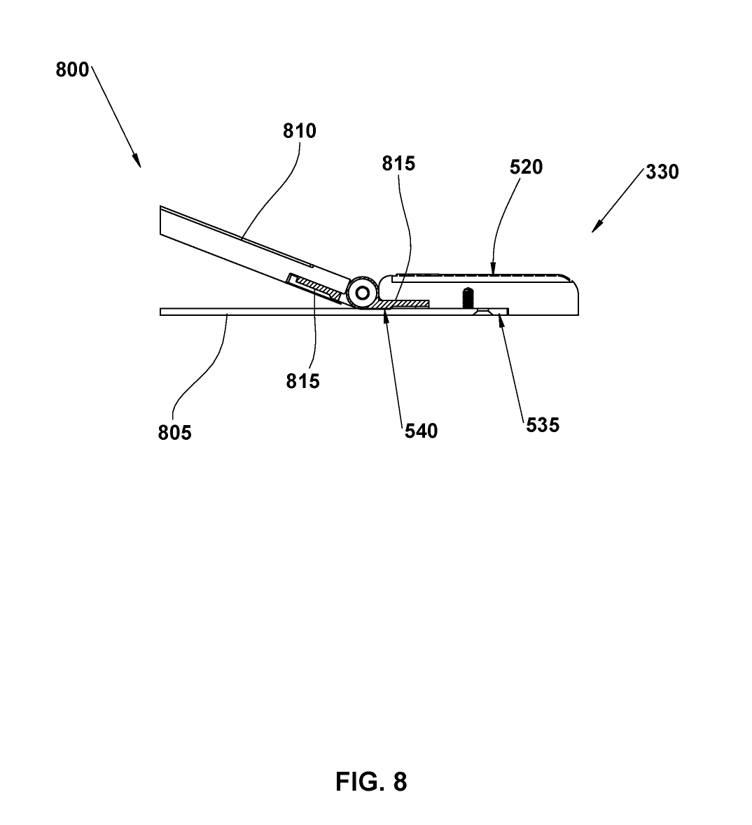

FIG. 8 is an illustration of a side transparent view of one embodiment of a replacement heel pedestal top plate engaged with a tongue and a base plate. As shown in FIG. 8, one embodiment of the drum foot pedal 800 may comprise a base plate 805, a pedal 810, a tongue 815, and a replacement heel pedestal top plate 330. FIG. 8 shows that the slot opening 540 may be configured to matingly engage with the tongue 815 of a drum foot pedal 800. Similarly, the recessed portion 535 may be configured to matingly engage with a base plate 805 of a drum foot pedal 800. The replacement heel pedestal top plate 330 may be aligned with the drum foot pedal 800 such that the angle of the top surface 520 of the replacement heel pedestal top plate 330 relative to the pedal 810 of the drum foot pedal 800 may be between approximately 10 to 25 degrees, preferably 16 degrees.

FIG. 8 shows that the tongue 815 may comprise a hinge and two plate portions, one that engages with the replacement heel pedestal 330 and, preferably, the base plate 805, and the other that is connected to the foot pedal 810.

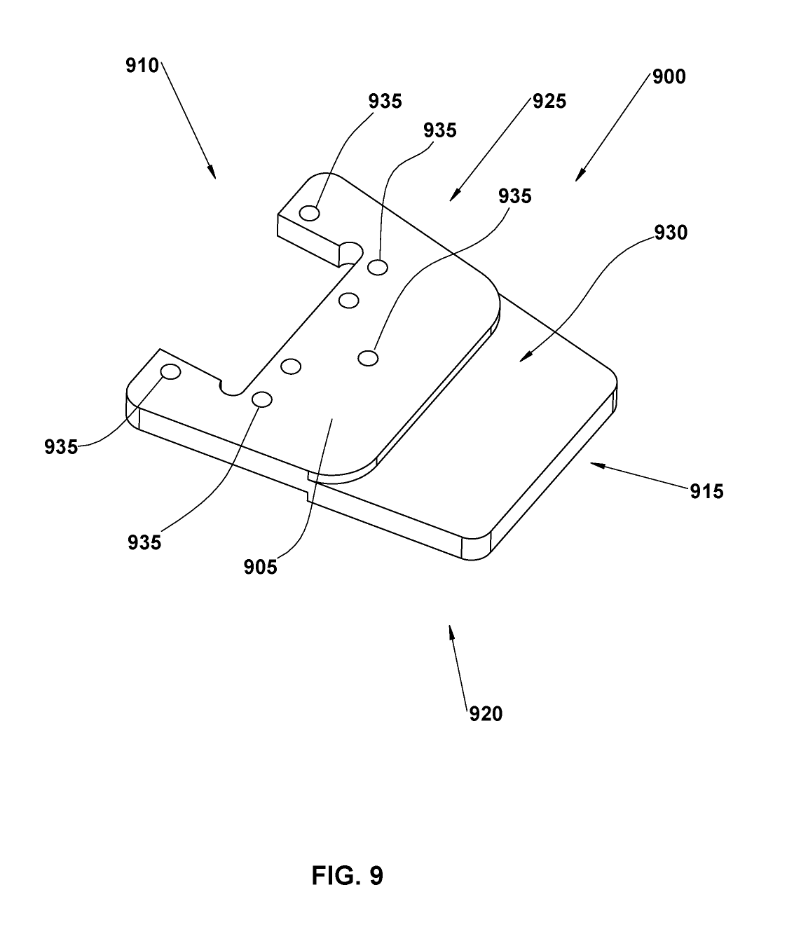

FIG. 9 is an illustration of a top perspective view of one embodiment of a level plate. As shown in FIG. 9, the level plate 900 may comprise a top 905, front 910, a rear 915, two sides 920, 925, and a bottom. The top 905 of the level plate 900 may comprise a recessed portion 930. The recessed portion 930 is preferably between the left side portion 920 and the right side portion 925. The recessed portion 930 may extend from the left side portion 920 to the right side portion 925. The recessed portion 930 may be configured to matingly engage with the recessed portion of the replacement heel pedestal top plate 330. The level plate 900 may be tapered from the front portion 910 to the rear portion 915. In this manner, the level plate 900 may better engage with the replacement heel pedestal top plate 330.

The level plate 900 may comprise one or more base plate holes 935, which may be generally configured to align with the base plate pilot holes of the replacement heel pedestal top plate 330 when the level plate 900 is matingly engaged with the replacement heel pedestal top plate 330. The base plate holes 935 of the level plate 900 may also be configured to align with the base plate fastener holes of the base plate of the drum foot pedal when the level plate 900 is engaged between the replacement pedestal the base plate of the drum foot pedal. The level plate 900 may be fastened to the replacement heel pedestal top plate and the base plate of the drum foot pedal via one or more fasteners. The fasteners may be any connection mechanism, device, or method, including, without limitation screws; self-tapping screws; bolts; nails; adhesives; welds; solders; ultrasonic welds; pins, keys; pegs; hook and loop; staples; buttons; zippers; anchors; rivets; grommets; latches; clasps; and clips. In the event that the level plate 900 is constructed from material that is engageable with self-tapping screws, the level plate holes 935 are not as necessary.

Preferably the level plate is about ½ as thick as the engagement plate. The primary purpose of the level plate is to allow the replacement pedestal 330 to connect to the base plate in a more level fashion. Base plates come in many different widths, sizes, and shapes and sometimes the pedestal 330 alone is not able to engage in a level manner when replacing the original heel plate. The level plate 900 is not designed to engage with the tongue, only the base plate. The level plate 900, as shown, may have a notch in the front 910 that substantially prevents the level plate from getting in the way of the replacement pedestal 330 connecting with the tongue.

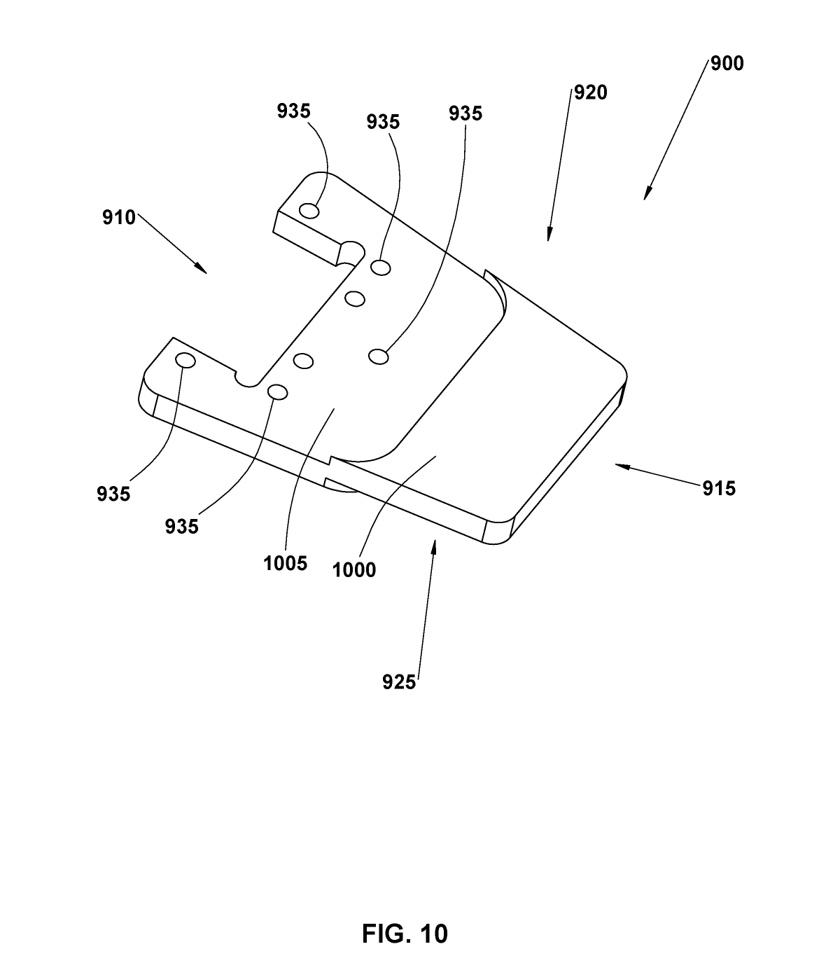

FIG. 10 is an illustration of a bottom perspective view of one embodiment of a level plate. As shown in FIG. 10, the level plate may comprise a top portion, front 910, a rear 915, two sides 920, 925, and a bottom surface 1000. The bottom portion 1000 of the level plate 900 may comprise a recessed portion 1005. The recessed portion 1005 is preferably between the left side portion 920 and the right side portion 925. The recessed portion 1005 may extend from the left side portion 920 to the right side portion 925. The recessed portion 1005 may be configured to matingly engage with the base plate of the drum foot pedal. The level plate 900 may be tapered from the front portion 910 to the rear portion 915. In this manner, the level plate 900 may better engage with the base plate of a drum foot pedal.

The level plate 900 may comprise one or more holes 935, which may be generally configured to align with the base plate fastener holes of the base plate of the drum foot pedal when the level plate 900 is engaged with the base plate of the drum foot pedal. The base plate holes 935 of the level plate 900 may also be configured to align with the base plate pilot holes of the replacement heel pedestal top plate when the level plate 900 is engaged with the replacement heel pedestal top plate. The level plate 900 may be fastened to the base plate of the drum foot pedal and the replacement heel pedestal top plate via one or more fasteners. The fasteners may be any connection mechanism, device, or method, including, without limitation screws; self-tapping screws; bolts; nails; adhesives; welds; solders; ultrasonic welds; pins, keys; pegs; hook and loop; staples; buttons; zippers; anchors; rivets; grommets; latches; clasps; and clips.

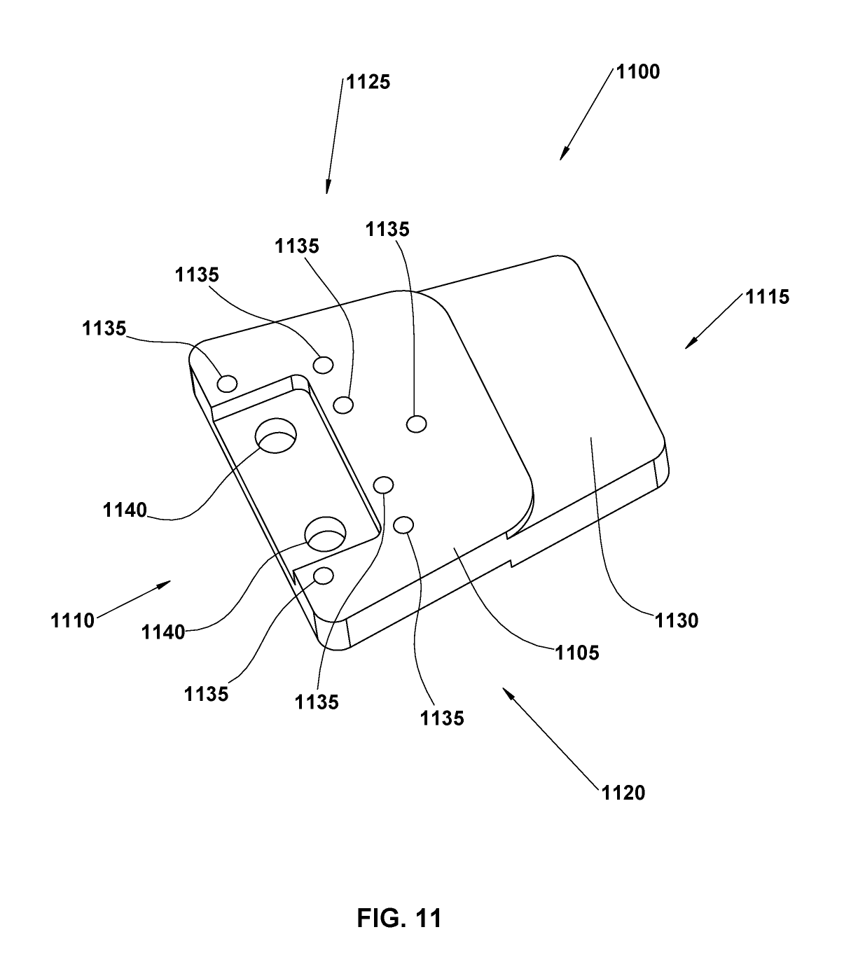

FIG. 11 is an illustration of a top perspective view of one embodiment of an elevation plate. As show in FIG. 11, the elevation plate 1100 may comprise a top 1105, front 1110, a rear 1115, two sides 1120, 1125, and a bottom. The top 1105 of the elevation plate 1100 may be substantially flat and may comprise a recessed portion 1130. The recessed portion 1130 is preferably between the left side 1120 and the right side 1125. The recessed portion 1130 may extend from the left side portion 1120 to the right side 1125. The recessed portion 1130 may be configured to matingly engage with the recessed portion of the replacement heel pedestal top plate 330. Alternatively, the recessed portion 1130 may be configured to matingly engage with the recessed portion of the bottom portion of the level plate, if used. In this manner, the level plate may be stacked between the replacement heel pedestal top plate and the elevation plate 1100. The elevation plate 1100 may be tapered from the front portion 1110 to the rear portion 1115. In this manner, the elevation plate 1100 may better engage with the replacement heel pedestal top plate 330 and/or the base plate.

The elevation plate 1100 may comprise one or more base plate and tongue holes 1135, 1140, which may be tongue pilot holes 1140 and base plate holes 1135. The holes 1135 may be openings larger than the pilot holes in the pedestal top plate 330 to allow for the screw head types to pass through entirely to attach the tongue to the top plate 330. Typically, the holes 1140 are smaller, but may be configured to allow a threaded screw shaft to pass substantially unimpeded.

In one embodiment, for the DW® 6000, the holes 1135 may not be used. The base frame and the tongue are both attached only through the tongue holes 1135. The tongue is put in place at the slotted opening and then the base frame connector portion is overlaid, and then the screws are put through to engage with the top plate pilot holes 605. In the event that an elevated portion is included, the base frame connector portion is overlaid at holes 1140, and then the screws pass through the base frame, through the holes 1140, through the tongue holes, and then engage with the top plate pilot holes 605. The tongue may be held in place by friction, a clip washer, or nut.

The tongue holes 1140 of the elevation plate 1100 are generally configured to align with the tongue pilot holes of the replacement heel pedestal top plate 330 when the tongue of the drum foot pedal is inserted into the slot opening of the replacement heel pedestal top plate. The tongue holes 1140 of the elevation plate 1100 may be configured to align with the tongue fastener holes of the base plate of the drum foot pedal when the elevation plate 1100 engages with the base plate of the drum foot pedal. In this manner the connector, usually a screw, passes through the base plate, then through the elevation plate, and into the top plate pilot holes 610. This allows the replacement pedestal system to be set to several different heights.

In one embodiment, if there is no base plate, the tongue may simply be connected to the replacement heel pedestal top plate, and the fasteners only engage with the tongue and the pedestal.

The base plate holes 1135 of the elevation plate 1100 may be configured to align with the base plate pilot holes of the replacement heel pedestal top plate when the elevation plate 1100 mates or engages with replacement heel pedestal top plate. The base plate holes 1135 of the elevation plate 1100 may be configured to align with the base plate fastener holes of the base plate of the drum foot pedal when one or more elevation plates 1100 mates or engages with base plate of the drum foot pedal.

Alternatively, the base plate holes 1135 of the elevation plate 1100 may be configured to align with the base plate pilot holes of the level plate when the top portion 1105 of the elevation plate 1100 mates or engages with the bottom portion of the level plate. In this manner, the level plate may be stacked in between the replacement heel pedestal top plate and the elevation plate 1100.

The elevation plate 1100 may be fastened to the replacement heel pedestal top plate, level plate, and/or base plate of the drum foot pedal via one or more fasteners. The fasteners may be any connection mechanism, device, or method, including, without limitation screws; self-tapping screws; bolts; nails; adhesives; welds; solders; ultrasonic welds; pins, keys; pegs; hook and loop; staples; buttons; zippers; anchors; rivets; grommets; latches; clasps; and clips.

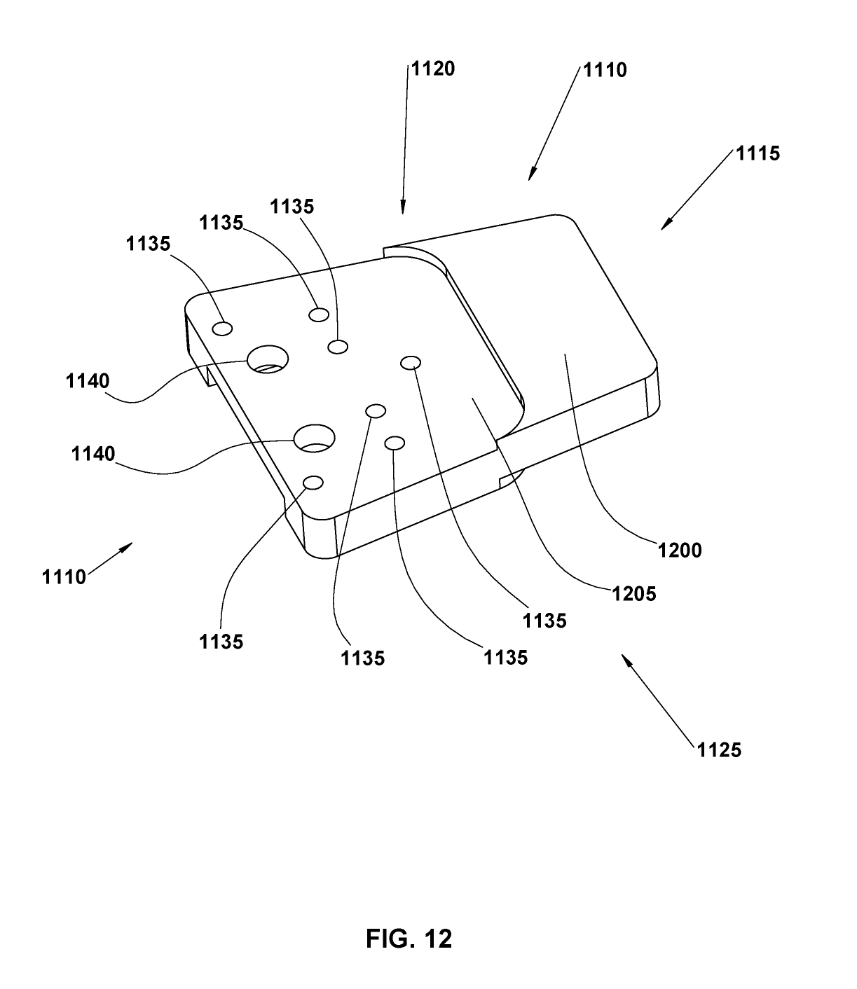

FIG. 12 is an illustration of a bottom perspective view of one embodiment of an elevation plate. As shown in FIG. 12, the elevation plate may comprise a top, front 1110, a rear 1115, two sides 1120, 1125, and a bottom surface 1200. The bottom surface 1200 of the elevation plate 1100, like the top may be substantially flat and may comprise a recessed portion 1205. The recessed portion 1205 is preferably between the left side 1120 and the right side 1125. The recessed portion 1205 may extend from the left side 1120 to the right side 1125. The recessed portion 1205 may be configured to matingly engage with the base plate of a drum foot pedal. When one or more elevation plates 1200 are used, the recessed portion 1205 may be configured to matingly engage with the recessed portion of the top portion of the other elevation plate 1200. The elevation plate 1200 may be tapered from the front portion 1110 to the rear portion 1115. In this manner, the elevation plate 1200 may better engage with the base plate of the drum foot pedal.

The elevation plate 1100 may comprise one or more holes 1135, 1140, which may be tongue holes 1140 (which are also called screw head opening holes, because they are primarily there to allow a screw to pass entirely through the hole) and base plate holes 1135. The tongue holes 1140 of the elevation plate 1100 are generally configured to align with the tongue pilot holes of the replacement heel pedestal top plate when the tongue of the drum foot pedal is inserted into the slot opening of the replacement heel pedestal top plate. The tongue holes 1140 of the elevation plate 1100 may be configured to align with the tongue fastener holes of the base plate of the drum foot pedal when the elevation plate 1100 mates or engages with base plate of the drum foot pedal. The base plate holes 1135 of the elevation plate 1100 may be configured to align with the base plate pilot holes of the replacement heel pedestal top plate when the elevation plate 1100 mates or engages with replacement heel pedestal top plate. The base plate holes 1135 of the elevation plate 1100 may be configured to align with the base plate fastener holes of the base plate of the drum foot pedal when the elevation plate 1100 mates or engages with base plate of the drum foot pedal.

Further, when one or more elevation plates 1110 are used, the tongue holes 1140 of a first elevation plate may be generally configured to align with the tongue holes 1140 of a second elevation plate. Similarly, the base plate holes 1135 of a first elevation plate may be generally configured to align with the base plate holes of a second elevation plate.

The elevation plate 1100 may be fastened to the replacement heel pedestal top plate, base plate of a drum foot pedal, and/or a second elevation plate via one or more fasteners. The fasteners may be any connection mechanism, device, or method, including, without limitation screws; self-tapping screws; bolts; nails; adhesives; welds; solders; ultrasonic welds; pins, keys; pegs; hook and loop; staples; buttons; zippers; anchors; rivets; grommets; latches; clasps; and clips.

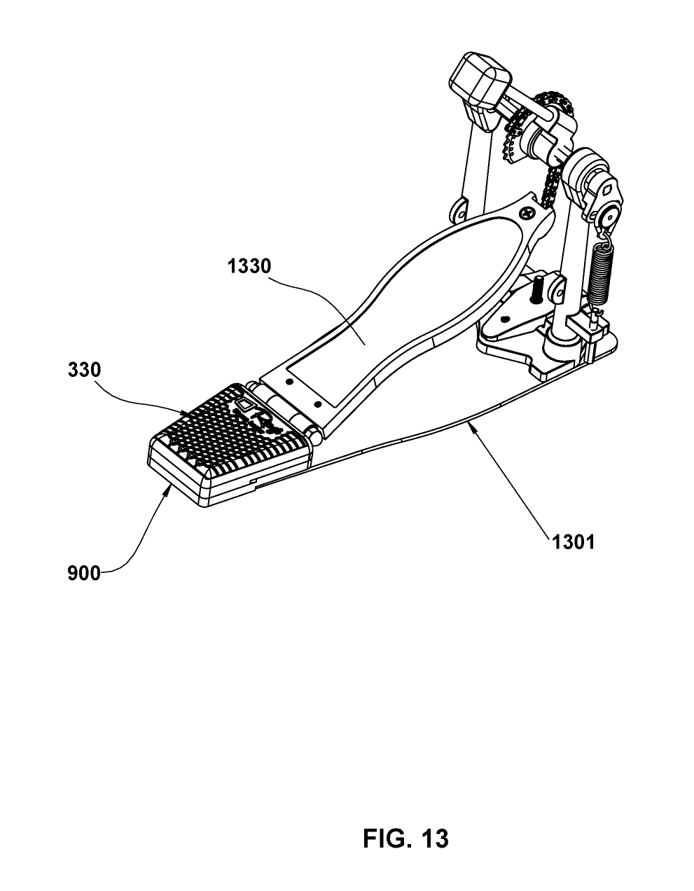

FIG. 13 is an illustration of an assembled perspective view of a drum foot pedal with a replacement heel pedestal top plate and a level plate. In one embodiment, the replacement heel pedestal top plate 330 may be removeably coupled to a level plate 900. The level plate 900 may aid the replacement heel pedestal top plate 330 to matingly engage with the base plate 1301 of the drum foot pedal 1300 when the replacement heel pedestal top plate 330 otherwise would not engage with the base plate 1301 in a level manner.

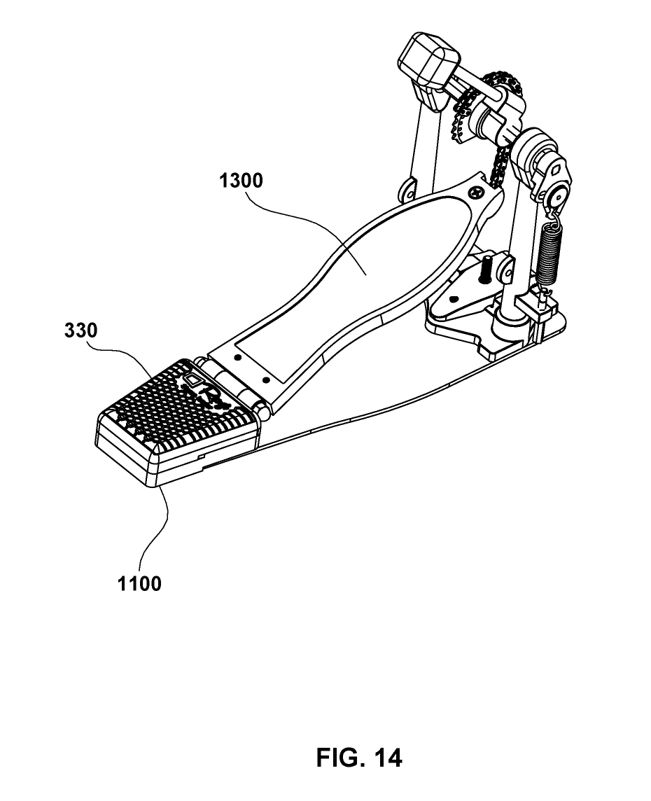

FIG. 14 is an illustration of an assembled perspective view of a drum foot pedal with a replacement heel pedestal top plate and an elevation plate. In one embodiment, the replacement heel pedestal top plate 330 may be removeably coupled to an elevation plate 1100. The elevation plate 1100 may provide an incremental adjustment for a more stable and/or elevated playing position for the foot and overall body positioning. This allows the foot to more easily access and engage with the foot board and provides more stability. By using correct orthopedic foot positioning relative to actuating the drum foot pedal 1300, a drummer may have more foot control, and less muscle, leg, and back fatigue, due to the proper alignment of the foot, ankle, and heel in relation to the leg, hip, and back posture while seated or standing during use.

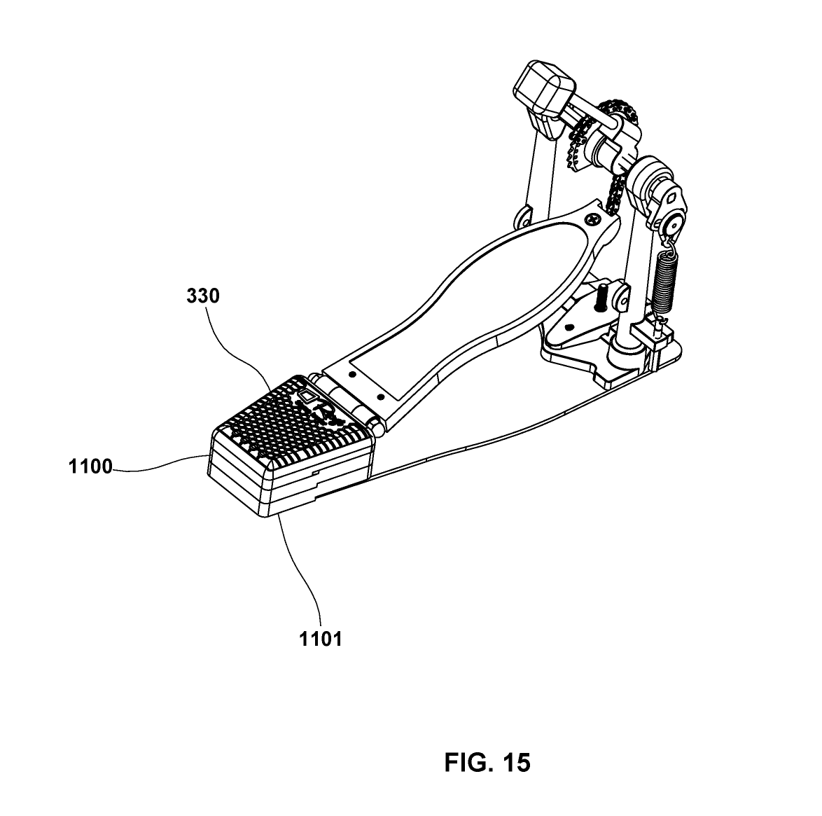

FIG. 15 is an illustration of an assembled perspective view of a drum foot pedal with a replacement heel pedestal top plate and more than one elevation plate. In one embodiment, the replacement heel pedestal top plate 330 may be removeably coupled to two elevation plates 1100, 1101.

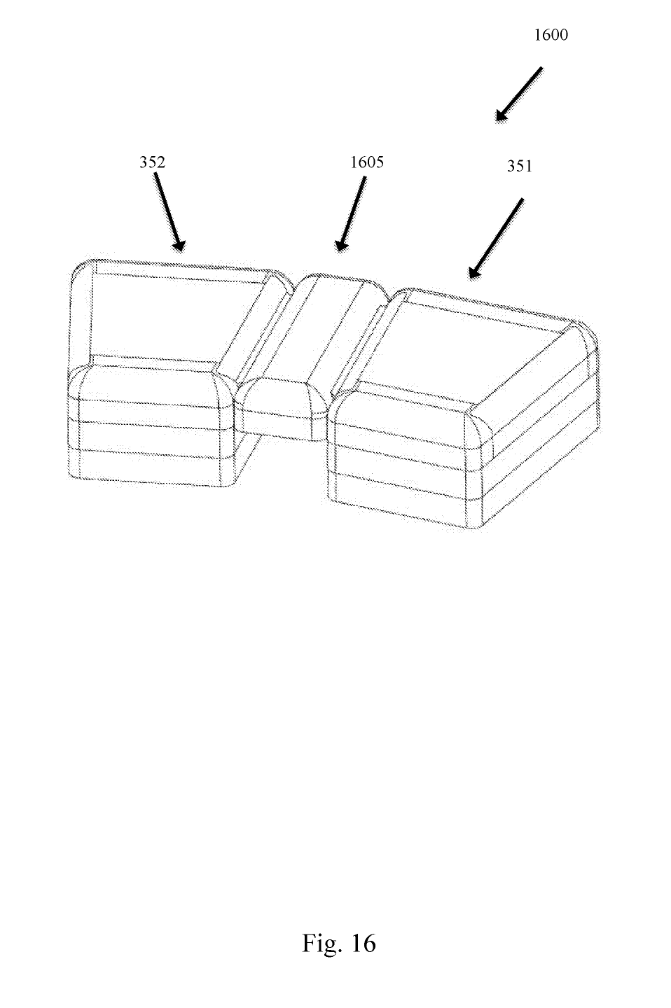

FIG. 16 is an illustration of a front elevational view of a drum foot pedal with two interconnected replacement heel pedestal systems. As shown in FIG. 16, the connector system 1600 may allow two or more replacement heel pedestal systems 351, 352 to be interconnected. The replacement heel pedestals 351, 352 may be removeably connected to each other via a connector plate 1605, wherein the connector plate 1605 may be between two replacement heel pedestal systems 351, 352. The connector plate 1605 may allow two or more drum foot pedals to be held securely in a conjoined configuration that may be adjusted as the user so desires. In this manner, the user may efficiently set up and switch back and forth between two or more replacement heel pedestal systems 351, 352.

In one embodiment, the connector plate 1605 may allow a drummer to attach multiple replacement heel pedestal systems 351, 352 together as a system for ease of playability and reduced drum foot pedal slippage when using multiple instruments.

The connector plate 1605 may comprise a single platform with double or triple grooves and risers, which may attach to the footprint of the replacement heel pedestal systems 351, 352. With the connector plate 1605, a drummer may place two or three drum foot pedals in sequence so that each drum foot pedal may be manipulated with either the right or left foot for ease of playability. The connector plate 1605 may provide additional stability for each drum foot pedal to reduce the probability of sliding on the floor by keeping more weight per square inch inside the plat replacement heel pedestal systems 351, 352 footprint, thus, allowing for more friction between the bottom of the replacement heel pedestal systems 351, 352 and the floor surface. This relieves an associated problem with many drum foot pedal systems due to the weight of the player's leg producing force down on the drum foot pedal creating more force on the traditional hook and loop strips and twist pins used to help reduce drum foot pedal slippage.

In another embodiment, the connector system 1600 may be designed as a “Push Bar System”, which may be located approximately one inch from the top and bottom on the left and right side of the connector plate 1605. The push bar system may be inset approximately one-eighth of an inch inward from the edge to the center of each slot in order to allow the push bar to slide into each designated slot on the replacement heel pedestal systems 351, 352 that are adjacent to one another so that the push bar secures each replacement heel pedestal systems together. This attachment embodiment requires a simple pressing of each push bar into each of the two replacement heel pedestal systems 351, 352 set-up next to one another for ease of playability of each instrument as well as providing additional stability for each drum foot pedal to reduce the probability of sliding on the floor by keeping more weight per square inch inside the replacement heel pedestal systems 351, 352 footprint, thus, allowing for more friction between the bottom of the replacement heel pedestal systems 351, 352 and the floor surface. This relieves an associated problem with many drum foot pedal systems due to the weight of the drummer's leg producing force down on the drum foot pedal creating more force on the traditional hook and loop strips and twist pins used to help reduce pedal system slippage.

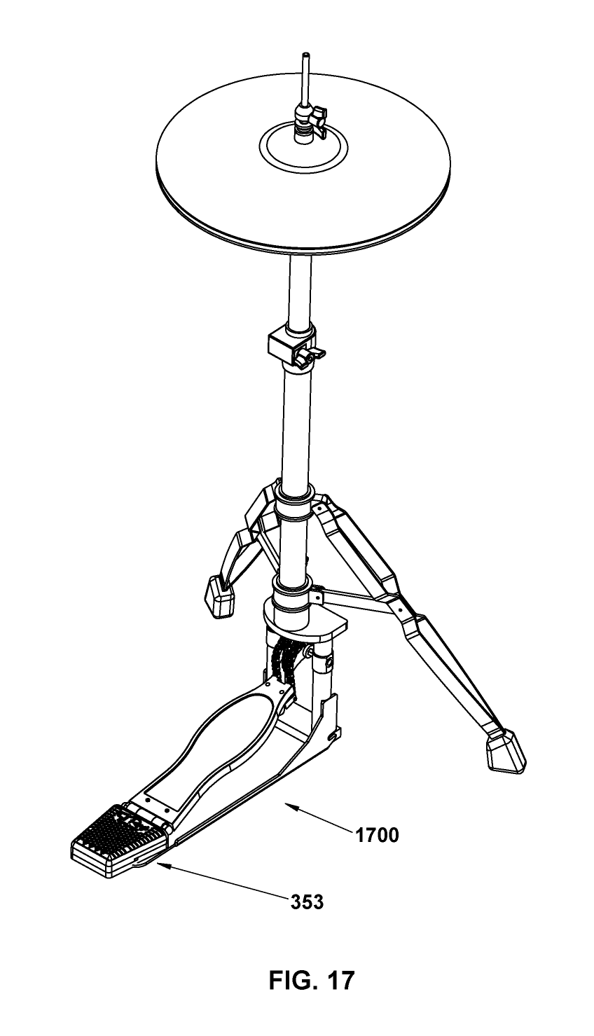

FIG. 17 is an illustration of an assembled perspective view of a hi-hat pedal with one embodiment of the replacement heel pedestal system. In one embodiment, the replacement heel pedestal system 353 may be used on a hi-hat stand foot pedal system 1700.

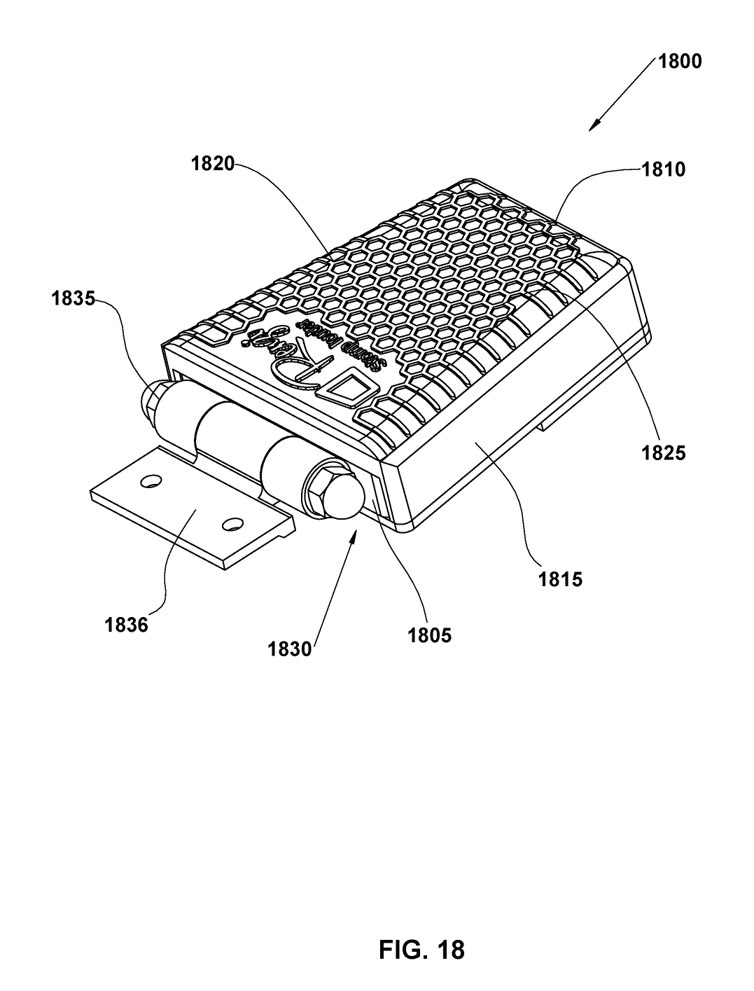

FIG. 18 is an illustration of a top perspective view of one embodiment of a cover system for covering an original heel plate of a foot pedal. In one embodiment, the replacement heel pedestal system may comprise a cover system 1800 for covering an original heel plate 1805, which is attached to a hinge 1835 and foot pedal tongue 1836. For purposes of clarity, the original foot pedal plate is shown as disconnected from the tongue 1836. The cover system 1800 may comprise: a front slot opening 1805, rear 1810, two sides 1815, 1820, top surface 1825, and bottom surface. The top surface 1825 of the cover system 1800 may be textured and softer for the comfort of the user. The texture may substantially similar to the texture of the top surface of replacement heel pedestal top plate 330 (as shown in FIG. 5) and may comprise various patterns, including, without limitation, a honeycomb pattern.

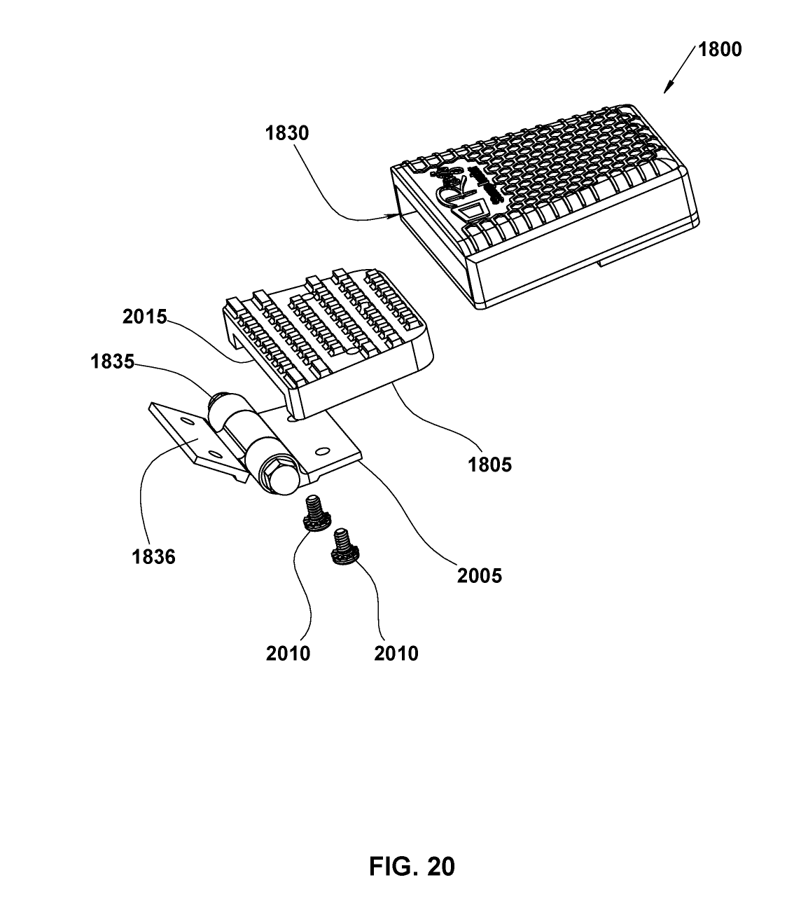

Additionally, FIG. 18 shows that the front 1805 of the cover system 1800 may taper to the rear 1810, such that the front portion 1805 is wider than the rear portion 1800. The cover system 1800 is preferably longer and wider than the heel plate 1805. Indeed, the cover system is preferably designed to substantially engulf the entirety of heel plate 1805. The front 1805 of the cover system 1800 may comprise a slot opening 1830, which is generally an opening used to receive the original heel plate 1805. The slot opening 1830 may also receive the tongue 2005 (shown in FIG. 20) of a drum foot pedal plate when the tongue 2005 is matingly engaged with the original heel plate 1805. The cover system 1800 may be configured to slip over or around the original heel plate and substantially form a replacement heel pedestal that provides more comfort and stability than the original heel plate 1805. This cover system 1800 may or may not require the removal of the original heel plate 1805. In this manner, the cover system 1800 may receive the original heel plate and be re-installed into its exact position on the base plate of the drum foot pedal.

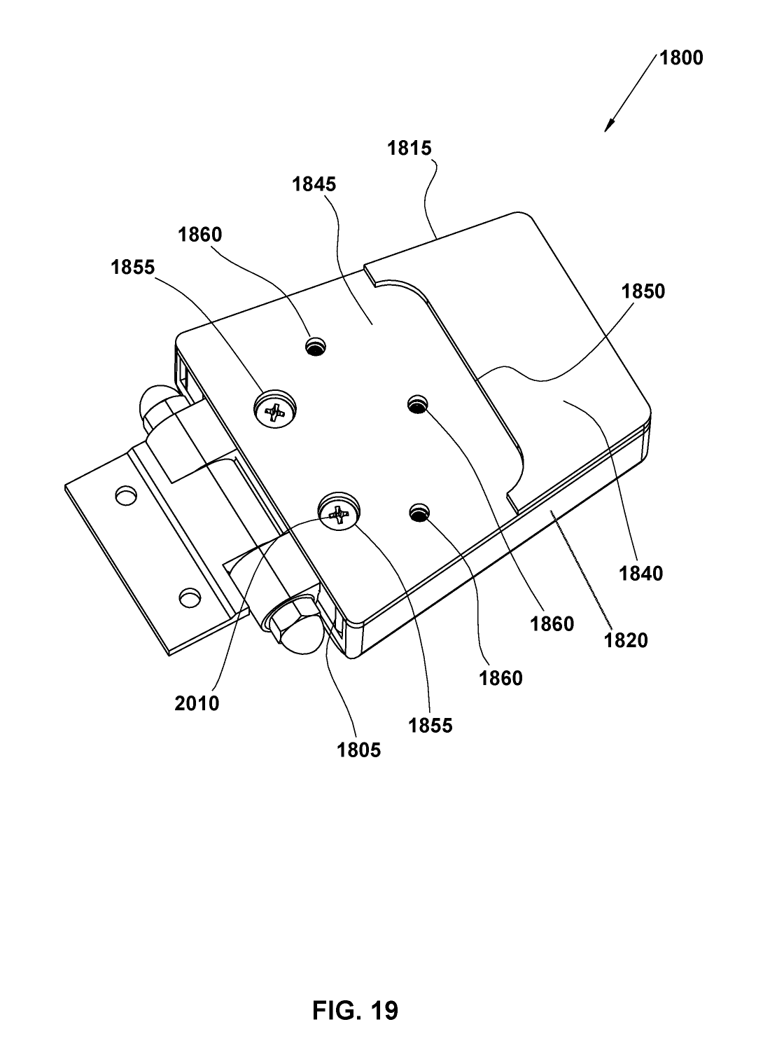

FIG. 19 is an illustration of a bottom perspective view of one embodiment of a cover system for covering an original heel plate of a foot pedal. As shown in FIG. 19, the bottom surface 1840 of the cover system 1800 may comprise a recessed portion 1845. The two sides 1815, 1820 may comprise a left side 1815 and a right side 1820. Accordingly, the recessed portion 1845 is preferably between the left side 1815 and the right side 1820 and may extend from the left side 1815 to the right side 1820. The end 1850 of the recessed portion 1845 may be configured to matingly engage with an end of a base plate (or frame) of a drum foot pedal. FIG. 19 shows how the cover system 1800 may substantially house the original heel plate the tongue 1835 of the drum foot pedal when the tongue 1835 is matingly engaged with the original heel plate.

FIG. 19 shows the cover system 1800 may comprise one or more holes 1855, 1860, which may be tongue holes 1855 and base plate holes 1860. The holes 1855, 1860 are generally positioned at the bottom surface 1840 of the cover system 1800. The tongue holes 1855 are generally configured to align with the tongue fastener holes of the tongue 2005 and the original heel plate tongue pilot holes.

In one embodiment, the a fastener, shown as screws 2010 in FIG. 19, may pass through the holes 1855, though the tongue fastener holes of the tongue 2005, and then engage with the tongue pilot holes of the original heel plate 1805. In another embodiment, the screws 2010 may further connect the cover system 1800 to the tongue 2005 and to the original heel plate 1805. In that embodiment, the holes 1855 are not as wide.

The base plate holes 1860 may be configured to align with the base plate fastener holes of a base plate (not shown) and the base plate pilot holes of the original heel plate 1805. In this manner, a fastener may pass though the base plate fastener holes, then through base plate holes 1860, and then engage with the base plate pilot holes of the original heel plate 1805, thus securing the cover system 1800 to the original heel plate 1805 and the base plate. The fasteners may be any connection mechanism, device, or method, including, without limitation screws; self-tapping screws; bolts; nails; adhesives; welds; solders; ultrasonic welds; pins, keys; pegs; hook and loop; staples; buttons; zippers; anchors; rivets; grommets; latches; clasps; and clips.

The holes 1855, 1860 may be positioned in various locations on the bottom surface 1840 of the cover system 1800, depending upon the location of the holes on the original heel plate and base plate of the drum foot pedal. In this manner, the cover system 1800 is versatile and may be used with various types and brands of drum foot pedals. The recessed portion 1845 may act just like the recessed portion of top plate 330 and may matingly engage with a base plate so that the cover system is secured and level.

FIG. 20 is an illustration of an exploded top perspective view of one embodiment of a cover system for covering an original heel plate of a foot pedal. FIG. 20 shows how the cover system 1800 is configured to slip over, otherwise engage with, or substantially engulf, the original heel plate 1805 and be secured thereto. The original heel plate 1805 may be configured to matingly engage the tongue 2005 of the drum foot pedal. The original heel plate 1805 may be secured to the tongue 2005 when the tongue 2005 is inserted into the slot opening 2015 of the original heel plate 1805. The tongue 2005 of the drum foot pedal may be secured to the original heel plate 1805 via one or more fasteners 2010. In this manner, the cover system 1800 may be configured to receive the original heel plate 1805 and the tongue 2005 of the drum foot pedal. The original heel plate 1805 and cover system 1800 may then be coupled to or matingly engage with the base plate, not shown.

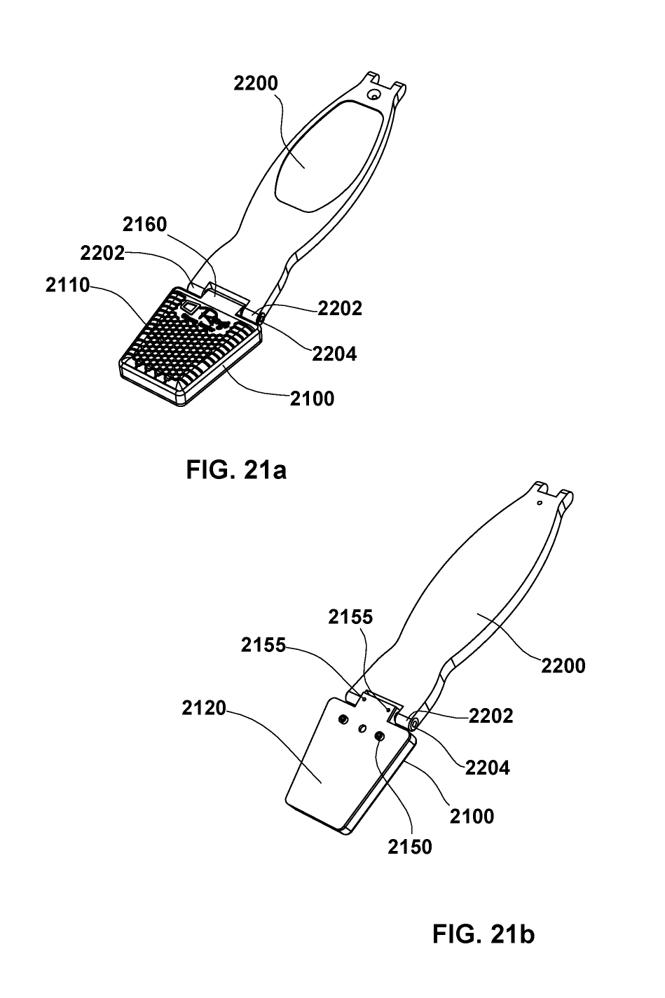

FIGS. 21a-b are illustrations of a top and bottom perspective view of another embodiment of a replacement heel pedestal device and system. FIGS. 21a-b show how a replacement heel pedestal system may comprise a replacement heel pedestal top plate 2100. The top plate 2100 may have a cushioned and textured top surface 2110, a bottom surface 2120, and hinge tab 2160 (also referred to as the male connector portion). Hinge tab 2160 is configured to engage with the foot pedal plate 2200 of the original foot pedal at foot pedal fork 2202. First, the original heel plate is removed and then the replacement heel pedestal top plate 2100 may matingly engage with foot pedal plate 2200. Specifically, the engagement may be a hinged connection and held together by one or more hinge pins 2204.

FIG. 21b shows that the top plate 2100 may have two fixed protruding slot stubs 2150, which are preferably designed to mate to corresponding slot recess points on a top surface of the base plate. There may be a plurality of slot recess points on the top of the base plate, which allow the user to adjust the entire heel pedestal and foot board, forward or backward, depending on how the user would like the heel pedestal and foot board to be positioned. Once the appropriate slot recess point is selected, the pedestal slot stubs 2150 are inserted into a corresponding recess point on the top of the base plate. Typically the points run in a vertical pattern at the exact same width as the slot stubs. In this manner, the heel pedestal and foot board may be secured to the base plate. The top plate 2100 may also have screw holes 2155 to allow the user to adjust the hinge.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A replacement heel pedestal system comprising:
a replacement heel pedestal top plate, configured to engage a foot pedal, and comprising: a front; a bottom; two sides; a top; a rear; a slot opening, and a recessed portion;
wherein said two sides comprise a left side and a right side;
wherein said slot opening is a female notch on said front and said bottom of said replacement heel pedestal top plate that engages and couples with a tongue of a foot pedal;
wherein said tongue is coupled to a foot pedal plate of said foot pedal, such that said replacement heel pedestal top plate and said foot pedal plate are hingedly coupled together;
wherein said recessed portion is on said bottom and said front of said replacement heel pedestal top plate; and
wherein said recessed portion is configured to engage with a base plate of said foot pedal.

2. The system of claim 1, wherein said slot opening comprises one or more tongue pilot holes; and
wherein said one or more tongue pilot holes are configured to align with one or more holes on said tongue, such that said tongue is allowed to matingly engage with and couple to said slot opening.

3. The system of claim 1, wherein said recessed portion of said replacement heel pedestal top plate comprises one or more base plate pilot holes; and
wherein said one or more base plate pilot holes are configured to align with one or more holes on said base plate, such that said base plate is allowed to matingly engage with and couple to said recessed portion.

4. The system of claim 1, wherein a surface of said top of said replacement heel pedestal top plate is textured, such that a user's foot is substantially prevented from slipping off said replacement heel pedestal top plate.

5. The system of claim 1, wherein a surface of said top of said replacement heel pedestal top plate is a soft material that absorbs a shock to a foot of a user.

6. The system of claim 1, wherein said replacement heel pedestal top plate tapers from said front of said replacement heel pedestal top plate to said rear of said replacement heel pedestal top plate, such that said front is wider than said rear.

7. The system of claim 2, wherein said replacement heel pedestal top plate is coupled to said tongue via one or more fasteners.

8. The system of claim 3, wherein said replacement heel pedestal top plate is coupled to said base plate of said foot pedal via one or more fasteners.

9. The system of claim 1, wherein said recessed portion is configured to matingly engage with said base plate, such that a heel end of said base plate engages with a proximal end of said recessed portion.

10. The system of claim 1, further comprising a level plate;
wherein said level plate is removeably coupled between said replacement heel pedestal top plate and said base plate, such that said replacement heel pedestal system is more level with respect to said foot pedal.

11. The system of claim 1, further comprising one or more elevation plates;
wherein said one or more elevation plates are removeably coupled between said replacement heel pedestal top plate and said base plate, such that a foot of a user is placed in an elevated playing position.

12. The system of claim 10, wherein said replacement heel pedestal system is wider and longer than an original heel plate and replaces said original heel plate.

13. The system of claim 1, wherein said replacement heel pedestal top plate further comprises four top edges and four top corners that are substantially rounded.

14. A replacement heel pedestal system comprising:
a replacement heel pedestal top plate, configured to engage a foot pedal, and comprising: a front; a bottom; two sides; a top; a rear; a slot opening, and a recessed portion;
wherein said two sides comprise a left side and a right side;
wherein said slot opening is a female notch on said front and said bottom of said replacement heel pedestal top plate that engages and couples with a tongue of a foot pedal;
wherein said tongue is coupled to a foot pedal plate of said foot pedal, such that said replacement heel pedestal top plate and said foot pedal plate are hingedly coupled together;
wherein said recessed portion is on said bottom and said front of said replacement heel pedestal top plate;
wherein said recessed portion engages with a base plate of said foot pedal; and
wherein a surface of said top of said replacement heel pedestal top plate is a soft material that absorbs a shock to a foot of a user.

15. The system of claim 14, wherein said slot opening comprises one or more tongue pilot holes; and
wherein said one or more tongue pilot holes are configured to align with one or more holes on said tongue, such that said tongue is allowed to matingly engage with and couple to said slot opening;
wherein said recessed portion of said replacement heel pedestal top plate comprises one or more base plate pilot holes; and
wherein said one or more base plate pilot holes are configured to align with one or more holes on said base plate, such that said base plate is allowed to matingly engage with and couple to said recessed portion.

16. The system of claim 15, wherein said replacement heel pedestal top plate is coupled to said tongue via one or more tongue fasteners;
wherein said replacement heel pedestal top plate is coupled to said base plate of said foot pedal via one or more base fasteners.

17. The system of claim 15, wherein said recessed portion is configured to matingly engage with said base plate, such that a heel end of said base plate engages with a proximal end of said recessed portion.

18. The system of claim 17, wherein a surface of said top of said replacement heel pedestal top plate is textured, such that a user's foot is substantially prevented from slipping off said replacement heel pedestal top plate.

19. The system of claim 18, further comprising a level plate;
wherein said level plate is removeably coupled between said replacement heel pedestal top plate and said base plate, such that said replacement heel pedestal system is more level with respect to said foot pedal.

20. The system of claim 17, further comprising one or more elevation plates;
wherein said one or more elevation plates are removeably coupled between said replacement heel pedestal top plate and said base plate, such that a foot of a user is placed in an elevated playing position.

21. The system of claim 14, wherein said replacement heel pedestal system is wider and longer than an original heel plate and replaces said original heel plate.

22. A method of replacing an original heel plate of a foot pedal with a replacement heel pedestal system comprising:
providing a foot pedal;
wherein said foot pedal comprises: a foot pedal plate, an original heel plate, a base plate, and a tongue;
wherein said original heel plate is connected to said base plate and said tongue via one or more fasteners;
removing said one or more fasteners from said original heel plate;
removing said original heel plate from said foot pedal;
providing a replacement heel pedestal top plate wherein said replacement heel pedestal top plate comprises: a front; a bottom; two sides; a top;
a rear; a slot opening, and a recessed portion;
wherein said two sides comprise a left side and a right side;
wherein said slot opening is a female notch on said front and said bottom of said replacement heel pedestal top plate;
coupling said tongue to said slot opening, such that said replacement heel pedestal top plate and said foot pedal plate are hingedly coupled together;
wherein said recessed portion is on said bottom and said front of said replacement heel pedestal top plate;
coupling said base plate to said recessed portion of said replacement heel pedestal top plate.

23. The method of claim 22, further comprising removeably coupling a level plate between said replacement heel pedestal top plate and said base plate.

24. The method of claim 22, further comprising removeably coupling one or more elevation plates between said replacement heel pedestal top plate and said base plate.
